(19) United States
(12) Patent Application Publication
(10) Pub. No.: US 2024/0399776 A1
(43) Pub. Date: Dec. 5, 2024

(54) COLOR DEVELOPER, THERMAL RECORDING MATERIAL, AND THERMAL RECORDING LAYER COATING MATERIAL

(71) Applicant: SANKO CO., LTD., Fukuoka (JP)

(72) Inventors: Yoshimi ISHIBASHI, Osaka (JP); Ryoichi KINISHI, Osaka (JP)

(73) Assignee: SANKO CO., LTD., Fukuoka (JP)

(21) Appl. No.: 18/270,119

(22) PCT Filed: Dec. 24, 2021
(86) PCT No.: PCT/JP2021/048438

§ 371 Date: Aug. 14, 2024

(30) Foreign Application Priority Data
Dec. 28, 2020 (JP) 2020-219044
Feb. 2, 2021 (JP) 2021-014999

(51) Int. Cl. B41M 5/333

(52) U.S. Cl. CPC B41M 5/3336; B41M 2205/40

(57) ABSTRACT

A color developer for a thermal recording layer includes: a compound of formula (I):

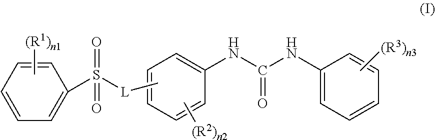

; and an N-substituted amino acid derivative of formula (II): (R⁰—X)—Y—(Z). The color developer is excellent in plasticizer resistance.

### TECHNICAL FIELD

The present invention relates to a color developer, a thermal recording material, and a thermal recording layer coating material.

### BACKGROUND ART

Thermal recording materials in each of which a thermal recording layer is provided on a support are used in various industrial fields. A thermal recording layer that includes a basic dye which is colorless or light-colored at normal temperature and an organic color developer and that allows color developing recording by applying thermal energy (Joule heat) such as a thermal head, a thermal pen, and the like, and a thermal recording material including such a thermal recording layer have been widely put into practical use.

The required performance of the printed part formed by the thermal recording layer in the thermal recording material is influenced by, for example, a basic dye, a color developer, a sensitizer, and the like, which are components of the thermal recording layer, and in particular, the influence of the color developer is large. As color developers, synthetic compounds derived from petrochemicals such as phenolic compounds, sulfonylurea compounds, and the like have been proposed. Among them, many phenolic compounds have been developed and put into practical use.

However, since some phenolic compounds are suspected of being endocrine disrupting substances, their use tends to be suppressed in recent years. For this reason, various non-phenolic color developers have been proposed as color developers in place of phenolic compounds.

For example, as the non-phenol color developer, there have been proposed an N-(phenylureidophenyl)benzenesulfonamide compound (Patent Literature 1), a phenylureidophenyl-benzenesulfonate compound such as 3-(3-phenylureido)phenyl-4-methylbenzenesulfonate (Patent Literature 2), and the like.

### CITATION LIST

### Patent Literature

Patent Literature 1: WO 2014/080615

Patent Literature 2: WO 2017/111032

### SUMMARY OF INVENTION

### Technical Problem

However, the N-(phenylureidophenyl)benzenesulfonamide compound described in

Patent Literature 1 and the phenylureidophenyl-benzenesulfonate compound such as 3-(3-phenylureido) phenyl-4-methylbenzenesulfonate described in Patent Literature 2 have good printing properties and the like, but have low plasticizer resistance, and there is a possibility that the printed part fads away when a plasticizer coexists.

Hence, an object of the present invention is to provide a color developer, a thermal recording material, and a thermal recording layer coating material, which are excellent in plasticizer resistance.

### Solution to Problem

In order to achieve the above object, the present invention provides a color developer for a thermal recording layer, including:

a compound of formula (I); and

an N-substituted amino acid derivative of formula (II),

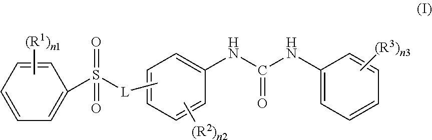

wherein in the formula (I),
L represents an imino group (—NH—) or an oxy group (—O—);
R¹, R² and R³ each represent a hydrogen atom, a halogen atom, a nitro group, an alkyl group, a cycloalkyl group, an alkoxy group, a cycloalkyloxy group, an alkenyl group, a fluoroalkyl group, an N(R⁴)₂ group (wherein R⁴ represents a hydrogen atom, a phenyl group, a benzyl group, or an alkyl group having 1 to 6 carbon atoms), an NHCOR⁵ group (wherein R⁵ represents an alkyl group having 1 to 6 carbon atoms), an optionally substituted phenyl group, an optionally substituted benzyl group, an aryloxy group, an alkylcarbonyloxy group, an arylcarbonyloxy group, an alkylcarbonylamino group, an arylcarbonylamino group, an alkylsulfonylamino group, or an arylsulfonylamino group;
n1, n2 and n3 each independently represent an integer of 0 to 5;
R¹, R² and R³ are identical to or different from one another;
when two or more R¹s are present, R¹s are identical to or different from each other;
when two or more R²s are present, R²s are identical to or different from each other; and
when two or more R³s are present, R³s are identical to or different from each other,

(R⁰—X)—Y—(Z) (II)

wherein in the formula (II),
R⁰ represents an alkyl group having an aryl group having 6 to 10 carbon atoms or an aryl group optionally substituted with a substituent of an alkyl group having 1 to 8 carbon atoms, an aralkyl group having 7 to 11 carbon atoms, an aryl group having 6 to 10 carbon atoms, or an alkoxy group having 1 to 8 carbon atoms;
X represents a group bonded to an N-terminal of Y and represents —OCO—, —SO₂NHCO—, —NHCO—, —NHCS—, or —SO₂—;
Y represents an amino acid residue or a peptide residue, and an OH group of a serine residue, a threonine residue, an aspartic acid residue, a glutamic acid residue, or a tyrosine residue in the Y group is optionally substituted with an OR⁰ group or an OR″ group, and an SH group of a cysteine residue is optionally substituted with an SR⁰ group or an SR″ group, an NH group of a histidine residue is optionally substituted with an NR⁰ group or an NR∝0 group, an NH₂ group of a lysine residue or an ornithine residue is optionally substituted with an NHR⁰ group or an NHR′ group, R′ represents an amino protecting group, and R″ represents a carboxy protecting group, provided that Y is an amino acid residue other than a cystine residue or a peptide residue having no cystine residue;
Z is a group bonded to a C-terminal of Y and represents an OH group or an OR″ group;
R⁰, R′ and R″ are identical to or different from one another;
when two or more R⁰s are present, R⁰s are identical to or different from each other;
when two or more R′s are present, R′s are identical to or different from each other;
when two or more R″s are present, R″s are identical to or different from each other; and
two or more groups of R⁰, R′, and R″ are optionally bonded to each other to form a ring.

The present invention also provides a thermal recording material, including:

a support; and

a thermal recording layer on the support, wherein

the thermal recording layer includes:
a basic dye which is colorless or light-colored at normal temperature; and
a color developer for developing color upon contact with the basic dye by heating, wherein
the color developer is the color developer according to the present invention.

The present invention also provides a thermal recording layer coating material for use in forming a thermal recording layer, including:

a basic dye which is colorless or light-colored at normal temperature; and

a color developer for developing color upon contact with the basic dye by heating, wherein
the color developer is the color developer according to the present invention.

### ADVANTAGEOUS EFFECTS OF INVENTION

According to the present invention, it is possible to provide a color developer, a thermal recording material, and a thermal recording layer coating material, which are excellent in plasticizer resistance.

### DESCRIPTION OF EMBODIMENTS

As described above, in the color developer, the thermal recording material, and the thermal recording layer coating material, a compound of formula (I) is used in combination with an N-substituted amino acid derivative of formula (II) as the color developer. According to this, for example, it is possible to further improve the plasticizer resistance without deteriorating various good storage characteristics such as color development density of the compound of formula (I), whiteness, and the like.

The performance required for the thermal recording material includes, for example, the whiteness of a non-printed part, the color development density of a printed part, and the storage stability of the printed part under various environmental conditions.

The storage stability of the printed part refers to the performance of the remaining properties of the printed part concerning external factors such as the stability when the printed part is placed in an environment of heat or high humidity, the stability when the printed part is attached to water, the stability when the printed part is attached to oil or alcohol, or the stability when the printed part is attached to a plasticizer which is used to produce the plasticity of tanning or synthetic leather used in leather products such as wallets or the plasticity of film products.

In particular, thermal recording materials are often used in POS register paper. There is a possibility that the POS register paper is stored in leather or synthetic leather purse for a long time, and the printed part of the POS register paper fades away by the plasticizer. On the other hand, when thermal recording materials are used as food labels, a film product such as a wrap used may come into direct contact with food label paper, and a plasticizer of the film product may cause a printed part of the food label paper to fade away. As described above, the plasticizer resistance of the printed part is one of the most important factors in the storage stability of the thermal recording material.

As described above, since the color developer, the thermal recording material, and the thermal recording layer coating material of the present invention are excellent in plasticizer resistance, they are suitable for use in the POS register paper, the food label, and the like, but not limited thereto and can be used in a wide range of applications.

The compound of formula (I) is excellent in, for example, printing properties, heat resistance, moist heat resistance, water resistance, and the like. In the color developer, the thermal recording material, and the thermal recording layer coating material of the present invention, by using the compound of formula (I) in combination with the N-substituted amino acid derivative of formula (II), the plasticizer resistance can be further improved while maintaining excellent printing properties, heat resistance, moist heat resistance, water resistance, and the like of the compound of formula (I), for example.

In the color developer, the thermal recording material, and the thermal recording layer coating material of the present invention, when a compound of formula (I) is a phenylureidophenyl-benzenesulfonate compound of formula (I-2), by using an N-substituted amino acid derivative of formula (II) in combination, for example, moist heat resistance and heat resistance can further be improved. Thereby, for example, it is possible to suppress or prevent a phenomenon in which the printed part fades away due to problems of moist heat resistance and heat resistance.

In the present invention, when a compound (e.g, the compound of formula (I), the compound of formula (II), etc.) has isomers such as tautomers and stereoisomers (e.g., a geometric isomer, a conformer, and an optical isomer), any isomer can be used in the present invention, unless otherwise stated. Furthermore, when a compound can form a salt, the salt can be used in the present invention, unless otherwise stated. The salt may be an acid addition salt, or may be a base addition salt. Moreover, an acid that forms the acid addition salt may be either an inorganic acid or an organic acid, and a base that forms the base addition salt may be either an inorganic base or an organic base. The inorganic acid is not particularly limited, and examples thereof include sulfuric acid, phosphoric acid, hydrofluoric acid, hydrochloric acid, hydrobromic acid, hydroiodic acid, hypofluorous acid, hypochlorous acid, hypobromous acid, hypoiodous acid, fluorous acid, chlorous acid, bromous acid, iodous acid, fluorine acid, chloric acid, bromic acid, iodic acid, perfluoric acid, perchloric acid, perbromic acid, and periodic acid. The organic acid also is not particularly limited, and examples thereof include p-toluenesulfonic acid, methanesulfonic acid, oxalic acid, p-bromobenzenesulfonic acid, carbonic acid, succinic acid, citric acid, benzoic acid, and acetic acid. The inorganic base is not particularly limited, and examples thereof include ammonium hydroxides, alkali metal hydroxides, alkaline-earth metal hydroxides, carbonates, and hydrogencarbonates. More specifically, examples of the inorganic base include sodium hydroxide, potassium hydroxide, potassium carbonate, sodium carbonate, sodium hydrogencarbonate, potassium hydrogencarbonate, calcium hydroxide, and calcium carbonate. The organic base also is not particularly limited, and examples thereof include ethanolamine, triethylamine, and tris(hydroxymethyl)aminomethane. The method for producing these salts also is not particularly limited. For example, they can be produced by adding an acid or a base such as described above to the compound as appropriate by a known method. Moreover, in the present invention, a chain substituent (e.g., an alkyl group,

hydrocarbon groups such as an unsaturated aliphatic hydrocarbon group, etc.) may be straight-chain or branched, unless otherwise stated, and the number of carbons thereof is not particularly limited, and may be, for example, 1 to 40, 1 to 32, 1 to 24, 1 to 18, 1 to 12, 1 to 6, or 1 to 2 (at least 2 in the case of an unsaturated hydrocarbon group). Furthermore, in the present invention, as to a cyclic group (e.g., an aryl group, a heteroaryl group, etc.), the number of ring members (the number of carbons that compose a ring) is not particularly limited and may be, for example, 5 to 32, 5 to 24, 6 to 18, 6 to 12, or 6 to 10. When a substituent or the like has isomers, any isomer can be used, unless otherwise stated. For example, in the case of simply describing as a “naphthyl group”, it may be a 1-naphthyl group or a 2-naphthyl group.

In the color developer, the thermal recording material, and the thermal recording layer

coating material of the present invention, the compound of formula (I) may be, for example, an N-(phenylureidophenyl)benzenesulfonamide compound of formula (I-1).

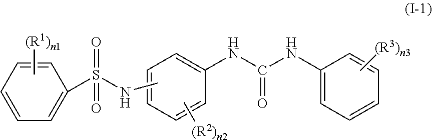

In the formula (I-1),

R¹, R² and R³ each represent a hydrogen atom, a halogen atom, a nitro group, an alkyl group having 1 to 6 carbon atoms, a cycloalkyl group having 1 to 6 carbon atoms, an alkoxy group having 1 to 6 carbon atoms, a cycloalkyloxy group having 1 to 6 carbon atoms, an alkenyl group having 2 to 6 carbon atoms, a fluoroalkyl group having 1 to 6 carbon atoms, an N(R⁴)₂ group (wherein R⁴ represents a hydrogen atom, a phenyl group, a benzyl group, or an alkyl group having 1 to 6 carbon atoms), an NHCOR⁵ group (wherein R⁵ represents an alkyl group having 1 to 6 carbon atoms), an optionally substituted phenyl group, or an optionally substituted benzyl group;
n1 and n3 each independently represent an integer of 1 to 5;
n2 represents an integer of 1 to 4;
R¹, R² and R³ may be identical to or different from one another;
when two or more R¹s are present, R¹s may be identical to or different from each other;
when two or more R²s are present, R²s may be identical to or different from each other; and
when two or more R³s are present, R³s may be identical to or different from each other.

In the formula (I-1), the halogen atom is not particularly limited, and examples thereof include fluorine atoms, chlorine atoms, bromine atoms, and iodine atoms.

In the formula (I-1), the alkyl group having 1 to 6 carbon atoms is not particularly limited, and examples thereof include linear or branched alkyl groups such as methyl, ethyl, a propyl group, an isopropyl group, a butyl group, an isobutyl group, a sec-butyl group, a t-butyl group, a pentyl group, an isopentyl group, a neopentyl group, a hexyl group, and an isohexyl group.

In the formula (I-1), the cycloalkyl group having 1 to 6 carbon atoms is not particularly limited, and examples thereof include cyclic cycloalkyl groups such as a cyclopropyl group, a cyclobutyl group, a 2-methylcyclopropyl group, a cyclopropylmethyl group, a cyclopentyl group, and a cyclohexyl group.

In the formula (I-1), the alkoxy group having 1 to 6 carbon atoms is not particularly limited, and examples thereof include linear or branched alkoxyl groups such as a methoxy group, an ethoxy group, a propoxy group, an isopropoxy group, a butoxy group, an isobutoxy group, a sec-butoxy group, a t-butoxy group, a pentyloxy group, an isopentyloxy group, a neopentyloxy group, a hexyloxy group, and an isohexyloxy group.

In the formula (I-1), the cycloalkoxy group having 1 to 6 carbon atoms is not particularly limited, and examples thereof include cyclic alkoxyl groups such as a cyclopropyloxy group, a cyclobutyloxy group, a 2-methylcyclopropyloxy group, a cyclopropylmethyloxy group, a cyclopentyloxy group, and a cyclohexyloxy group.

In the formula (I-1), the alkenyl group having 2 to 6 carbon atoms is not particularly limited, and examples thereof include a vinyl group, an allyl group, an isopropenyl group, a 1-propenyl group, a 2-propenyl group, a 1-butenyl group, a 2-butenyl group, a 3-butenyl group, 1,3-butanedienyl group, and a 2-methyl-2-propenyl group.

In the formula (I-1), the fluoroalkyl group having 1 to 6 carbon atoms is not particularly limited, and examples thereof include a trifluoromethyl group, a perfluoroethyl group, a perfluoropropyl group, a perfluorobutyl group, a perfluorohexyl group, and a perfluorocyclohexyl group.

In the formula (I-1), the N(R⁴)₂ group is not particularly limited, and examples thereof include amino groups in which R⁴ is a hydrogen atom, a phenyl group, a benzyl group, or an alkyl group having 1 to 6 carbon atoms.

In the formula (I-1), the NHCOR⁵ group is not particularly limited, and examples thereof include a methylcarbonylamino group, an ethylcarbonylamino group, a propylcarbonylamino group, an isopropylcarbonylaminocarbonylamino group, a butylcarbonylaminocarbonylamino group, an isobutylcarbonylaminocarbonylamino group, a sec-butylcarbonylamino group, a t-butylcarbonylamino group, a pentylcarbonylamino group, an isopentylcarbonylamino group, a neopentylcarbonylamino group, a hexylcarbonylamino group, an isohexylcarbonylamino group, a cyclopropylcarbonylamino group, a cyclobutylcarbonylamino group, a 2-methylcyclopropylcarbonylamino group, a cyclopropylmethylcarbonylamino group, a cyclopentylcarbonylamino group, and a cyclohexylcarbonylamino group.

In the formula (I-1), examples of the substituent of the optionally substituted phenyl group and the optionally substituted benzyl group include the alkyl group having 1 to 6 carbon atoms, the alkoxy group having 1 to 6 carbon atoms, the cycloalkyloxy group having 1 to 6 carbon atoms, the alkenyl group having 2 to 6 carbon atoms, the fluoroalkyl group having 1 to 6 carbon atoms, an N(R⁴)₂ group (wherein R⁴ represents a hydrogen atom, a phenyl group, a benzyl group, or an alkyl group having 1 to 6 carbon atoms), and an NHCOR⁵ group.

The N-(phenylureidophenyl)benzenesulfonamide compound of formula (I-1) is not particularly limited, and examples thereof include 4-methyl-N-[2-(3-phenylureido) phenyl]benzenesulfonamide and N-[2-(3-phenylureido) phenyl]benzenesulfonamide.

In the color developer, the thermal recording material, and the thermal recording layer coating material of the present invention, the compound of formula (I) may be, for example, a phenylureidophenyl-benzenesulfonate compound of formula (I-2).

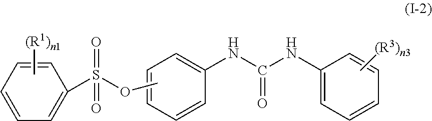

In the formula (I-2),

R¹ and R³ each represent an alkyl group, a cycloalkyl group, an alkoxy group, a cycloalkyloxy group, an aryloxy group, an alkylcarbonyloxy group, an arylcarbonyloxy group, an alkylcarbonylamino group, an arylcarbonylamino group, an alkylsulfonylamino group, or an arylsulfonylamino group;
n1 and n3 each independently represent an integer of 0 to 5;
R¹ and R³ may be identical to or different from each other;
when two or more R¹s are present, R¹s may be identical to or different from each other; and
when two or more R³s are present, R³s may be identical to or different from each other.

In the formula (I-2), the alkyl group of R¹ and R³ is preferably an alkyl group having 1 to 6 carbon atoms. The alkyl group having 1 to 6 carbon atoms is not particularly limited, and examples thereof include linear or branched alkyl groups such as methyl, ethyl, a propyl group, an isopropyl group, a butyl group, an isobutyl group, a sec-butyl group, a tert-butyl group, a pentyl group, an isopentyl group, a neopentyl group, a hexyl group, and an isohexyl group. Among them, a methyl group is particularly preferable.

In the formula (I-2), the cycloalkyl group of R¹ and R³ is preferably a cycloalkyl group having 1 to 6 carbon atoms. The cycloalkyl group having 1 to 6 carbon atoms is not pacrticulaly limited and examples thereof include a cyclopropyl group, a cyclobutyl group, a 2-methylcyclopropyl group, a cyclopropylmethyl group, a cyclopentyl group, and a cyclohexyl group.

In the formula (I-2), the alkoxy group of R¹ and R³ is preferably an alkoxy group having 1 to 6 carbon atoms. The alkoxy group having 1 to 6 carbon atoms is not particularly limited, and examples thereof include linear or branched alkoxyl groups such as a methoxy group, an ethoxy group, a propoxy group, an isopropoxy group, a butoxy group, an isobutoxy group, a sec-butoxy group, a t-butoxy group, a pentyloxy group, an isopentyloxy group, a neopentyloxy group, a hexyloxy group, and an isohexyloxy group.

In the formula (I-2), the cycloalkyloxy group of R¹ and R³ is preferably a cycloalkyloxy group having 1 to 6 carbon atoms. The cycloalkyloxy group having 1 to 6 carbon atoms is not particularly limited, and examples thereof include cyclic cycloalkyloxy groups such as a cyclopropyloxy group, a cyclobutyloxy group, a 2-methylcyclopropyloxy group, a cyclopropylmethyloxy group, a cyclopentyloxy group, and a cyclohexyloxy group.

In the formula (I-2), the aryl group of the aryloxy group, the arylcarbonyloxy group, the arylcarbonylamino group, or the arylsulfonylamino group of R¹ and R³ is not particularly limited, and examples thereof include a phenyl group and a naphthyl group. Examples of the naphthyl group include a 1-naphthyl group and a 2-naphthyl group.

In the formula (I-2), the alkyl group of the alkylcarbonyloxy group, the alkylcarbonylamino group, or the alkylsulfonylamino group is not particularly limited, and is preferably, for example, the alkyl group having 1 to 6 carbon atoms, and particularly preferably a methyl group.

In the formula (I-2), n1 is preferably 0 or 1, and more preferably 1. n3 is preferably 0 or 1, and more preferably 0. When n1 is 1, the substituent position of R¹ is preferably the ortho position or the para position, and more preferably the para position. When n3 is 1, the substituent position of R² is preferably the ortho position or the para position, and more preferably the para position.

The phenylureidophenyl-benzenesulfonate compound of formula (I-2) is not particularly limited, and examples thereof include the following compounds.

### Examples (1) of Phenylureidophenyl-Benzenesulfonate Compound of Formula (I-2)

3-(3-phenylureido)phenyl-4-methylbenzenesulfonate, 4-(3-phenylureido)phenyl-4-methylbenzenesulfonate, 2-(3-phenylureido)phenyl-4-methylbenzenesulfonate, 3-(3-phenylureido) phenyl-2-methylbenzenesulfonate, 4-(3-phenylureido)phenyl-2-methylbenzenesulfonate, 2-(3-phenylureido)phenyl-2-methylbenzenesulfonate, 3-(3-phenylureido) phenyl-3-methylbenzenesulfonate,4-(3-phenylureido)phenyl-3-methylbenzenesulfonate, 2-(3-phenylureido)phenyl-3-methylbenzenesulfonate, 3-(3-phenylureido) phenyl-benzenesulfonate, 4-(3-phenylureido)phenyl-benzenesulfonate, 2-(3-phenylureido) phenyl-benzenesulfonate

Examples (2) of phenylureidophenyl-benzenesulfonate compound of formula (I-2) 3-[3-(4-methylphenylureido)]phenyl-4-methylbenzenesulfonate, 4-[3-(4-methylphenylureido)]phenyl-4-methylbenzenesulfonate, 2-[3-(4-methylphenylureido)]phenyl-4-methylbenzenesulfonate, 3-[3-(4-methylphenylureido)]phenyl-2-methylbenzenesulfonate, 4-[3-(4-methylphenylureido)]phenyl-2-methylbenzenesulfonate, 2-[3-(4-methylphenylureido)]phenyl-2-methylbenzenesulfonate, 3-[3-(4-methylphenylureido)]phenyl-3-methylbenzenesulfonate, 4-[3-(4-methylphenylureido)]phenyl-3-methylbenzenesulfonate, 2-[3-(4-methylphenylureido)]phenyl-3-methylbenzenesulfonate, 3-[3-(4-methylphenylureido)]phenyl-benzenesulfonate, 4-[3-(4-methylphenylureido)]phenyl-benzenesulfonate, 2-[3-(4-methylphenylureido)]phenyl-benzenesulfonate

### Examples (3) of Phenylureidophenyl-Benzenesulfonate Compound of Formula (I-2)

3-[3-(2-methylphenylureido)]phenyl-4-methylbenzenesulfonate, 4-[3-(2-methylphenylureido)]phenyl-4-methylbenzenesulfonate, 2-[3-(2-methylphenylureido)]phenyl-4-methylbenzenesulfonate, 3-[3-(2-methylphenylureido)]phenyl-2-methylbenzenesulfonate, 4-[3-(2-methylphenylureido)]phenyl-2-methylbenzenesulfonate, 2-[3-(2-methylphenylureido)]phenyl-2-methylbenzenesulfonate, 3-[3-(2-methylphenylureido)]phenyl-3-methylbenzenesulfonate, 4-[3-(2-methylphenylureido)]phenyl-3-methylbenzenesulfonate, 2-[3-(2-methylphenylureido)]phenyl-3-methylbenzenesulfonate, 3-[3-(2-methylphenylureido)]phenyl-benzenesulfonate, 4-[3-(2-methylphenylureido)]phenyl-benzenesulfonate, 2-[3-(2-methylphenylureido)]phenyl-benzenesulfonate

### Examples (4) of Phenylureidophenyl-Benzenesulfonate Compound of Formula (I-2)

3-[3-(3-methylphenylureido)]phenyl-4-methylbenzenesulfonate, 4-[3-(3-methylphenylureido)]phenyl-4-methylbenzenesulfonate, 2-[3-(3-methylphenylureido)]phenyl-4-methylbenzenesulfonate, 3-[3-(3-methylphenylureido)]phenyl-2-methylbenzenesulfonate, 4-[3-(3-methylphenylureido)]phenyl-2-methylbenzenesulfonate, 2-[3-(3-methylphenylureido)]phenyl-2-methylbenzenesulfonate, 3-[3-(3-methylphenylureido)]phenyl-3-methylbenzenesulfonate, 4-[3-(3-methylphenylureido)]phenyl-3-methylbenzenesulfonate, 2-[3-(3-methylphenylureido)]phenyl-3-methylbenzenesulfonate, 3-[3-(3-methylphenylureido)]phenyl-benzenesulfonate, 4-[3-(3-methylphenylureido)]phenyl-benzenesulfonate, 2-[3-(3-methylphenylureido)]phenyl-benzenesulfonate

### Examples (5) of Phenylureidophenyl-Benzenesulfonate Compound of Formula (I-2)

3-(3-phenylureido)phenyl-4-propyloxybenzenesulfonate, 4-(3-phenylureido)phenyl-4-propyloxybenzenesulfonate, 2-(3-phenylureido)phenyl-4-propyloxybenzenesulfonate, 3-(3-phenylureido) phenyl-4-phenyloxybenzenesulfonate, 4-(3-phenylureido phenyl-4-phenyloxybenzenesulfonate, 2-(3-phenylureido)phenyl-4-phenyloxybenzenesulfonate, 3-(3-phenylureido) phenyl-4-ethylcarbonyloxybenzenesulfonate, 4-(3-phenylureido)phenyl-4-ethylcarbonyloxybenzenesulfonate, 2-(3-phenylureido)phenyl-4-ethylcarbonyloxybenzenesulfonate, 3-(3-phenylureido)phenyl-4-ethylcarbonylaminobenzene sulfonate, 4-(3-phenylureido)phenyl-4-ethylcarbonylaminobenzene sulfonate, 2-(3-phenylureido) phenyl-4-ethylcarbonylaminobenzene sulfonate

### Examples (6) Phenylureidophenyl-Benzenesulfonate Compound of Formula (I-2)

3-(3-phenylureido)phenyl-4-phenylcarbonylaminobenzenesulfonate, 4-(3-phenylureido) phenyl-4-phenylcarbonylaminobenzenesulfonate, 2-(3-phenylureido)phenyl-4-phenylcarbonylaminobenzenesulfonate, 3-(3-phenylureido)phenyl-4-(2-propylsulfonylamino) benzenesulfonate, 4-(3-phenylureido)phenyl-4-(2-propylsulfonylamino) benzenesulfonate, 2-(3-phenylureido)phenyl-4-(2-propylsulfonylamino) benzenesulfonate, 3-(3-phenylureido)phenyl-4-phenylsulfonylaminobenzenesulfonate, 4-(3-phenylureido)phenyl-4-phenylaminobenzenesulfonate, 2-(3-phenylureido)phenyl-4-phenylsulfonylaminobenzene sulfonate

Hereinafter, in the present specification, the compound of formula (I) may be referred to as a “color developer (B)”. Examples of the color developer (B) of formula (I) include the N-(phenylureidophenyl) benzenesulfonamide compound of formula (I-1) and the phenylureidophenyl-benzenesulfonate compound of formula (I-2).

In the thermal recording layer coating material of the present invention or the thermal recording layer in the thermal recording material of the present invention, the content of the color developer (B) is not particularly limited, and from the viewpoint of the color development density, the color developer (B) is preferably present in an amount from 30 to 800 parts by mass, more preferably from 50 to 500 parts by mass, and still more preferably from 100 to 400 parts by mass per 100 parts of the basic dye of the thermal recording layer.

In the color developer, the thermal recording material, and the thermal recording layer coating material of the present invention, the color developer includes an N-substituted amino acid derivative of formula (II) as described above.

(R⁰—X)—Y—(Z) (II)

In the formula (II), as described above, R⁰ represents an alkyl group having an aryl group having 6 to 10 carbon atoms or an aryl group optionally substituted with a substituent of an alkyl group having 1 to 8 carbon atoms, an aralkyl group having 7 to 11 carbon atoms, an aryl group having 6 to 10 carbon atoms, or an alkoxy group having 1 to 8 carbon atoms. Examples of the alkyl group having an aryl group having 6 to 10 carbon atoms include a benzyl group, a phenethyl group, an o-tolylmethyl group, a m-tolylmethyl group, a p-tolylmethyl group, an o-tolylethyl group, a m-tolylethyl group, and a p-tolylethyl group. Examples of the aryl group optionally substituted with a substituent of the alkyl group having 1 to 8 carbon atoms include an o-tolyl group, a m-tolyl group, a p-tolyl group, a 1-ethylphenyl group, a 2-ethylphenyl group, a 3-ethylphenyl group, a 1-propylphenyl group, a 2-propylphenyl group, a 3-propylphenyl group, a 1-butylphenyl group, a 2-butylphenyl group, a 3-butylphenyl group, a 1-pentylphenyl group, a 2-pentylphenyl group, and a 3-pentylphenyl group. Examples of the aryl group optionally substituted with a substituent of an aralkyl group having 7 to 11 carbon atoms include a p-benzylbiphenyl group and the like. Examples of the aryl group optionally substituted with a substituent of the aryl group having 6 to 10 carbon atoms include a biphenyl group and a 3,3′-dimethylbiphenyl group. Examples of the aryl group optionally substituted with a substituent of the alkoxy group having 1 to 8 carbon atoms include a 6-methoxyphenyl group and the like.

In the formula (II), as described above, X is a group bonded to an N-terminal of Y and represents —OCO—, —SO₂NHCO—, —NHCO—, —NHCS—, or —SO₂— (sulfonyl group).

In the formula (II), as described above, Y represents an amino acid residue or a peptide residue, and an OH group of the serine residue, the threonine residue, the aspartic acid residue, the glutamic acid residue, or the tyrosine residue in the Y group may be substituted with an OR⁰ group or an OR″ group, and an SH group of the cysteine residue may be substituted with an SR⁰ group or an SR″ group, an NH group of the histidine residue may be substituted with an NR⁰ group or an NR' group, an NH₂ group of the lysine residue or the ornithine residue may be substituted with an NHR⁰ group or an NHR′ group, R′ represents an amino protecting group, and R″ represents a carboxy protecting group. Examples of the amino protecting group (R′ group) that protects an NH group of the histidine residue or an NH₂ group of the lysine residue or the ornithine residue in the Y group include, besides a R⁰X group, an acyl group, and an alkyl group. Examples of the carboxy protecting group (R″ groups) that protects the aspartic acid residue or the glutamic acid residue in the Y group include an alkoxy group, an aryloxy group, an amino group, an alkylamino group, and an arylamino group. Examples of the protecting group of the OH group of the serine residue, the threonine residue, or the tyrosine residue or the SH group of the cysteine residue in the Y group include the above-mentioned carboxy-protecting groups (R″ groups).

However, as described above, Y is an amino acid residue other than a cystine residue or a peptide residue having no cystine residue.

In the formula (II), as described above, Z is a group bonded to a C-terminal of Y and represents an OH group or an OR″ group.

In the formula (II), as described above,

R⁰, R′ and R″ may be identical to or different from one another;
when two or more R⁰s are present, R⁰s may be identical to or different from each other;
when two or more R′s are present, R′s may be identical to or different from each other;
when two or more R″s are present, R″s may be identical to or different from each other; and
two or more groups of R⁰, R′, and R″ may be bonded to each other to form a ring.

The method for producing an N-substituted amino acid derivative of formula (II) is not particularly limited, and the N-substituted amino acid derivative can be easily produced from an amino acid or an amino acid derivative with a sulfonic acid chloride, an isocyanate compound, or the like by using a known method such as the Schottenbauman reaction.

The amino acid, peptide, and ester/amide thereof used as components of the N-substituted amino acid derivative of formula (II) are not particularly limited, and may be, for example, in a L-form, in a D-form, or in a DL-form. The amino acid may be, for example, a natural amino acid, a non-natural amino acid, an α-amino acid, or a β-amino acid. The ester is not particularly limited, and examples thereof include alkyl ester, aryl ester, and aralkyl ester having 1 to 4 carbon atoms. The amide is not particularly limited, and examples thereof include amide, alkyl-substituted amide, and aryl-substituted amide.

Specific examples of the amino acid, peptide, and ester/amide thereof used as components of the N-substituted amino acid derivative of formula (II) include glycine; ester derivatives such as, glycine methyl ester, glycine ethyl ester, glycine-tert-butyl ester, glycine phenyl ester, glycine p-cresyl ester, glycine m-cresyl ester, glycine benzyl ester, and the like; amide derivatives such as glycine amide, N′-methyl glycine amide, glycylanilide, and the like; phenylglycine; ester derivatives such as phenylglycine methyl ester, phenylglycine ethyl ester, phenylglycine benzyl ester, and the like; phenylglycine amide; alanine; ester derivatives such as alanine methyl ester, alanine ethyl ester, alanine benzyl ester, and the like; alanine amide; phenylalanine; naphthylalanine; ester derivatives such as phenylalanine methyl ester, phenylalanine ethyl ester, phenylalanine benzyl ester, and the like; amide derivatives such as phenylalanine amide, N′-methylphenylalanine amide, phenylalanyl anilide, and the like; valine; ester derivatives such as valine methyl ester, valine methyl ester, valine isopropyl ester, valine-tert-butyl ester, valine benzyl ester, and the like; valine amide; leucine; leucine methyl ester; isoleucine; serine; o-substituted serines such as o-methyl serine, o-benzyl serine, and the like; ester derivatives such as serine methyl ester, serine benzyl ester, and the like; threonine; o-substituted threonines such as o-methyl threonine, o-benzyl threonine, and the like; ester derivatives such as threonine methyl ester, threonine-tert-butyl ester, and the like; tyrosine, o-substituted tyrosines such as o-methoxy tyrosine, o-benzyloxy tyrosine, tyrosine, and the like; 3-(3′,4′-dihydroxyphenyl)alanine (DOPA); ester derivatives such as tyrosine methyl ester, tyrosine benzyl ester, and the like; tyrosine amide; proline; hydroxyproline; ester derivatives such as proline methyl ester, proline-tert-butyl ester, proline benzyl ester, and the like; proline amide; lysine; ornithine; ester derivatives such as lysine methyl ester, lysine ethyl ester, lysine benzyl ester, ornithine methyl ester, ornithine ethyl ester, ornithine benzyl ester, and the like; arginine; arginine methyl ester; arginine ethyl ester; histidine; histidine methyl ester; tryptophan; tryptophan methyl ester; ryptophan benzyl ester; tryptophan amide; cysteine; cystine; S-substituted cysteines such as S-methyl cysteine, S-ethyl cysteine, S-benzyl cysteine, S-phenyl cysteine, and the like; ester derivatives such as cysteine methyl ester, cysteine benzyl ester, and the like; S-oxidized derivatives such as cysteine sulfoxide, sulfone, and the like; methionine; S-oxidized derivatives such as methionine sulfoxide, methionine sulfone, and the like; ester derivatives such as methionine methyl ester, methionine benzyl ester, and the like; methionine amide; aspartic acid; ester derivatives such as aspartic acid methyl ester, aspartic acid ethyl ester, aspartic acid benzyl ester, and the like; asparagine; glutamic acid: ester derivatives such as glutamic acid methyl ester, glutamic acid ethyl ester, glutamic acid benzyl ester, and the like; and glutamine. Furthermore, the amino acid, peptide, and ester/amide thereof used as components of the N-substituted amino acid derivative of formula (II) may be an amino acid such as homoserine, homocysteine, norleucine and derivatives thereof. In addition, aminocarboxylic acids having 1 to 8 carbon atoms such as β-alanine, 5-aminovaleric acid, and 7-aminoheptanoic acid may also be selected.

The peptide is not particularly limited, and examples thereof include glycylglycine, glycylglycine methyl ester, glycylglycine amide, glycylalanine, glycylalanine methyl ester, glycylvaline, glycylleucine, glycylphenylalanine, glycylphenylalanine methyl ester, glycylphenylalanine amide, glycylproline, alanylalanine, alanylproline, alanylmethionine, alanylmethionine methyl ester, alanylphenylalanine, and glycylglycylglycine.

The N-substituted amino acid derivative of formula (II) is, for example, an amino-group-protected amino acid, a peptide, or a derivative thereof. The protecting group is not particularly limited, and may be, for example, a protecting group commonly used in the field of amino acid chemistry or peptide synthesis chemistry.

In the color developer, the thermal recording material, and the thermal recording layer coating material of the present invention, the functional group (—XNH-group) formed by the N-substituent of N-substituted amino acid derivative of formula (II) is not particularly limited, and examples thereof include a sulfonylamino group, a urethane group, a (thio)urea group (ureido), and a sulfonylurea group. Among these functional groups, the sulfonylamino group is derived from arylsulfonyl chloride, for example. The urethane group is derived from chloroformates such as benzyl chloroformate, or carbonate ester such as diphenyl carbonate. The (thio)urea group is derived from an iso(thio)cyanate ester such as phenyl iso(thio)cyanate. The sulfonylurea is derived from a sulfonylurea such as toluenesulfonyl isocyanate.

The compound (X1) that forms a sulfonylamino group is not particularly limited, and specific examples thereof include chlorides such as benzenesulfonyl chloride, p-toluenesulfonyl chloride, m-toluenesulfonyl chloride, o-toluenesulfonyl chloride, p-methoxybenzenesulfonyl chloride, p-xylenesulfonyl chloride, m-xylenesulfonyl chloride, mesitylenesulfonyl chloride, 1-naphthalenesulfonyl chloride, 2-naphthalenesulfonyl chloride, and the like; bromides; and iodides.

The compound (X2) that forms a urethane group is not particularly limited, and examples thereof include halogenated formate esters such as chloroformate benzyl ester, chloroformate phenyl ester, and the like; and carbonate esters such as diphenyl carbonate, dibenzyl carbonate, and the like.

The compound (X3) which forms a (thio)urea group is not particularly limited, and examples thereof include benzyl isocyanate, phenyl isocyanate, p-tolyl isocyanate, m-tolyl isocyanate, o-tolyl isocyanate, 1-naphthyl isocyanate, 2-naphthyl isocyanate, phenylene 1,4-diisocyanate (1,4-phenylene-diisocyanate), phenylene 1,3-diisocyanate (1,3-phenylene-diisocyanate), tolylene 2,4-diisocyanate, tolylene 2,6-diisocyanate, p-xylylene diisocyanate, m-xylylene diisocyanate, naphthalene 1,5-diisocyanate (1,5-naphthalenediyl-diisocyanate), 4,4′-diisocyanate-3,3′-dimethylbiphenyl, methylenediphenyl-4,4′-diisocyanate, 4,4′-diisocyanate-3,3′-dimethyldiphenylmethane, phenyl isothiocyanate, m-tolyl isothiocyanate, and p-tolyl isothiocyanate.

The compound (X4) that forms a sulfonylurea group is not particularly limited, and examples thereof include benzenesulfonyl isocyanate and p-toluenesulfonyl isocyanate.

In the formula (II), the N-substituted amino acid derivative obtained by using the compound (X1) that forms a sulfonylamino is not particularly limited, and examples thereof include N-arylsulfonyl-amino acids, esters, and amides such as N-benzenesulfonyl-glycine, N-benzenesulfonyl-glycine methyl ester, N-benzenesulfonyl-glycineamide, N-benzenesulfonyl-methionine methyl ester, N-benzenesulfonyl-cysteine-S-benzyl, N-(p-toluenesulfonyl)-glycine, N-(p-toluenesulfonyl)-alanine, N-(p-toluenesulfonyl)-β-alanine, N-(p-toluenesulfonyl)-phenylalanine N-(p-toluenesulfonyl)-phenylalanine methyl ester, N-(p-toluenesulfonyl)-phenylalanine benzyl ester, N-(p-toluenesulfonyl)-methionine, N-(p-toluenesulfonyl)-methioninebenzyl ester, N-(m-toluenesulfonyl)-isoleucine, 3-N-(o-toluenesulfonyl) aminocaproic acid, N-(2,4-xylenesulfonyl)-alanine, N-(2,4,6-mesitylenesulfonyl)-serine, N-(p-ethylbenzenesulfonyl)-threonine, N,N′-di (p-tert-butylbenzenesulfonyl)-lysine, N,N′-di(p-tert-butylbenzenesulfonyl)-ornithine, N-(1-naphthalenesulfonyl)-tryptophane, N-2-naphthalenesulfonyl-asparagine, and the like; N-aralkylsulfonyl-amino acids, esters, and amides such as N-benzylsulfonyl-valine, N-benzylsulfonyl-tyrosine, N-benzylsulfonyl-phenylglycine, and the like.

In the formula (II), the N-substituted amino acid derivative obtained by using the compound (X3) that forms a urea group is not particularly limited, and is preferably selected from the group consisting of N-phenylamino carbonyl-glycine, N-phenylamino carbonyl-glycine-methyl ester, N-phenylamino carbonyl-glycine benzyl ester, N-phenylamino carbonyl-glycinamide, N-phenylamino carbonyl-alanine, N-phenylamino carbonyl-alanine-methyl ester, N-phenylamino carbonyl-β-alanine, N-phenylamino carbonyl-methionine, N-phenylamino carbonyl-methionine-methyl ester, N-phenylamino carbonyl-glutamine, N,N′-di(phenylamino carbonyl)-lysine, N,N′-di(phenylamino carbonyl)-ornithine, N-phenylamino carbonyl-phenylalanine, N-phenylamino carbonyl-norvaline, N-(p-tolylaminocarbonyl)-glycine, N-(p-tolylaminocarbonyl)-alanine, N-(p-tolylaminocarbonyl)-valine, N-(p-tolylaminocarbonyl)-phenylalanine, N-(p-tolylaminocarbonyl)-cysteine-S-benzyl, N-(p-tolylaminocarbonyl)-methionine, N-(p-tolylaminocarbonyl)-glutamic acid, N-(p-tolylaminocarbonyl)-glutamine, N-(m-tolylaminocarbonyl)-glycine, N-(p-tolylaminocarbonyl)-glycyl glycine, N-(p-tolylaminocarbonyl)-glycylglycylglycine, N-(m-tolylaminocarbonyl)-glycylalanine, N-(m-tolylaminocarbonyl)-leucylalanine, N-(m-tolylaminocarbonyl)-methionine, N-(m-tolylaminocarbonyl)-methionine-sulfone, N-(m-tolylaminocarbonyl)-valine, N-(m-tolylaminocarbonyl)-tyrosine, N-(m-tolylaminocarbonyl)-tyrosine-methyl ester, N-(m-tolylaminocarbonyl)-phenylalanine, N-(p-tolylaminocarbonyl)-phenylalanine, N-(m-tolylaminocarbonyl)-methionine, N-(m-tolylaminocarbonyl)-valine, N-(m-tolylaminocarbonyl)-phenylglycine, N-phenylglycine, N-(3-isopropenyl-α, α-dimethylbenzyl) aminocarbonyl-methionine, and N-(m-tolylaminocarbonyl)-tyrosine.

Besides the aforementioned examples, examples of the N-substituted amino acid derivatives obtained by using the compound (X3) that forms a urea group include N-(m-tolylaminocarbonyl)-phenylalanine-methyl ester, N-(m-tolylaminocarbonyl)-phenylalanine-ethyl ester, N-(m-tolylaminocarbonyl)-phenylalanine-benzyl ester, N-(phenylamino carbonyl)-phenylalanine-methyl ester, N-(phenylamino carbonyl)-phenylalanine-ethyl ester, N-(phenylamino carbonyl)-phenylalanine-benzyl ester, N-(m-tolylaminocarbonyl)-β-phenylalanineamido, N,N′-di(m-tolylaminocarbonyl)-lysine, N,N′-di (m-tolylaminocarbonyl)-lysine-methyl ester, N,N′-di(m-tolylaminocarbonyl)-ornithine, N,N′-di(m-tolylaminocarbonyl)-ornithine-methyl ester, N-(m-tolylaminocarbonyl)-glutamic acid, N-(o-tolylaminocarbonyl)-alanine, N-(o-tolylaminocarbonyl)-homoserine, N-(o-tolylaminocarbonyl)-valine, 1,6-hexamethylenebis (N-aminocarbonyl-phenylalanine), 2,4-phenylenebis(N-aminocarbonyl-phenylalanine), and 1,3-tolylenebis(N-aminocarbonyl-phenylglycine).

In the formula (II), the N-substituted amino acid derivative obtained by using the compound (X3) that forms a thiourea group is not particularly limited, and examples thereof include N-phenylaminothiocarbonyl-phenylalanine, N-phenylaminothiocarbonyl-phenylalanine-methyl ester, N-phenylaminothiocarbonyl-valine-isopropyl ester, N-phenylaminothiocarbonyl-tyrosine-methyl ester, N-phenylaminothiocarbonyl-methionine-methyl ester, N-phenylaminothiocarbonyl-glycylglycine, N-phenylaminothiocarbonyl-glycylalanine, N-m-tolylaminothiocarbonyl-phenylalanine, N-m-tolylaminothiocarbonyl-phenylalanine-benzyl ester, N-m-tolylaminothiocarbonyl-phenylalanine amide, N-m-tolylaminothiocarbonyl-valine, N-m-tolylaminothiocarbonyl-valine-isopropyl ester, N-m-tolylaminothiocarbonyl-methionine-methyl ester, N-m-tolylaminothiocarbonyl-glycylglycine, N-p-tolylaminothiocarbonyl-phenylalanine, N-p-tolylaminothiocarbonyl-phenylalanine-benzyl ester, N-p-tolylaminothiocarbonyl-phenylalanine amide, N-p-tolylaminothiocarbonyl-valine, N-p-tolylaminothiocarbonyl-valine-isopropyl ester, N-p-tolylaminothiocarbonyl-methionine-methyl ester, and N-p-tolylaminothiocarbonyl-glycylglycine.

In the formula (II), the N-substituted amino acid derivative obtained by using the compound (X2) that forms a urethane group is not particularly limited, and examples thereof include N-benzyloxycarbonyl-glycine, N-benzyloxycarbonyl-phenylglycine, N-benzyloxycarbonyl-valine, N-benzyloxycarbonyl-methionine, N-benzyloxycarbonyl-tyrosine, N-benzyloxycarbonyl-hydroxyproline, N-benzyloxycarbonyl-arginine, and N-benzyloxycarbonyl-glycine.

In the formula (II), the N-substituted amino acid derivative obtained by using the compound (X4) that forms a sulfonylurea group is not particularly limited, and examples thereof include N-(p-toluenesulfonylaminocarbonyl)-glycine, N-(p-toluenesulfonylaminocarbonyl)-phenylalanine, N-(p-toluenesulfonylaminocarbonyl)-phenylalanine-methyl ester, N-(p-toluenesulfonylaminocarbonyl)-phenylalanine-ethyl ester, N-(p-toluenesulfonylaminocarbonyl)-phenylalanine amide, N-(p-toluenesulfonylaminocarbonyl)-β-alanine, N-(p-toluenesulfonylaminocarbonyl)-β-alanine-methyl ester, N-(p-toluenesulfonylaminocarbonyl)-methionine-methyl ester, N-(p-toluenesulfonylaminocarbonyl)-leucine, N,N′-di (p-toluenesulfonylaminocarbonyl)-lysine-methyl ester, and N,N′-di (p-toluenesulfonylaminocarbonyl)-ornithine-methyl ester.

In the N-substituted amino acid derivative of formula (II) in the color developer, the thermal recording material, and the thermal recording layer coating material of the present invention, examples of the amino protecting group (R′ group) that protects the NH₂ group of the histidine residue or the NH₂ group of the lysine residue or the ornithine residue in the Y group include, besides a R⁰X group, an acyl group, and an alkyl group. These amino protecting groups (R′ groups) can be introduced by known methods. For example, the acyl group can be introduced using an acid anhydride. The alkyl group can be introduced, for example, using an alkyl halide such as trityl chloride in the presence of an amine or the like.

In the N-substituted amino acid derivative of formula (II) in the color developer, the thermal recording material, and the thermal recording layer coating material of the present invention, examples of the carboxy protecting group (R″ group) that protects the aspartic acid residue or the glutamic acid residue in the Y group include an alkoxy group, an aryloxy group, an amino group, an alkylamino group, and an arylamino group. The protecting group of the OH group of the serine residue, the threonine residue, or the tyrosine residue or the SH group of the cysteine residue in the Y group may be the carboxy protecting group (R″ group). These carboxy protecting groups (R″ groups) can be introduced by known methods.

In the color developer, the thermal recording material, and the thermal recording layer coating material of the present invention, the N-substituted amino derivative of formula (II) preferred as the color developer is not particularly limited, and examples thereof include N-allylsulfonyl-amino acids such as N-(p-toluenesulfonyl)-glycine, N-(p-toluenesulfonyl)-alanine, N-(p-toluenesulfonyl)-β-alanine; and N-aminocarbonyl-amino acids such as N-phenylaminocarbonyl-glycine, N-phenylaminocarbonyl-valine, N-(m-tolylaminocarbonyl)-phenylalanine, N-(phenylaminocarbonyl)-phenylalanine, N-(m-tolylaminocarbonyl)-cysteine-S-benzyl, N-(m-tolylaminocarbonyl)-methionine, N-(m-tolylaminocarbonyl)-tyrosine, N-(p-tolylaminocarbonyl)-phenylalanine, N-(p-tolylaminocarbonyl)-cysteine-S-benzyl, N-(p-tolylaminocarbonyl)-methionine, N-(p-tolylaminocarbonyl)-methionine, N-(phenylaminocarbonyl)-methionine, N-(p-tolylaminocarbonyl)-tyrosine. Among them, N-(m-tolylaminocarbonyl)-phenylalanine, N-(phenylaminocarbonyl)-phenylalanine, N-(m-tolylaminocarbonyl)-methionine, N-(p-tolylaminocarbonyl)-methionine, N-(p-phenylaminocarbonyl)-methioninen, N-(m-tolylaminocarbonyl)-valine, N-(m-tolylaminocarbonyl)-phenylglycine, and N-m-tolylaminocarbonyl)-tyrosine are particularly preferable.

In the formula (II), Z is preferably an OH group, and X is preferably a —NHCO— group, and specifically, the N-substituted amino acid derivative is preferably at least one selected from the group consisting of N-(m-tolylaminocarbonyl)-phenylalanine, N-(m-tolylaminocarbonyl)-methionine, N-(p-tolylaminocarbonyl)-methionine, N-(phenylaminocarbonyl)-methionine, N-(m-tolylaminocarbonyl)-valine, N-(m-tolylaminocarbonyl)-phenylglycine, and N-(m-tolylaminocarbonyl)-tyrosine.

As the color developer of formula (II), one of these N-substituted amino acid derivatives may be used alone or two or more of them may be used in combination.

The N-substituted amino acid derivatives such as N-(m-tolylaminocarbonyl)-phenylalanine and N-(phenylaminocarbonyl)-phenylalanine of formula (II) used in the present invention have been found to be usable as a color developer by the inventors of the present invention as a result of the studies from the viewpoint of whether an amino acid which is also a food can be used as a thermal recording material. Since the basic amino group and the acidic carboxyl group coexist in the same molecule and are intramolecularly neutralized in an amino acid, the amino acid does not develop colors even when it comes into contact with the basic dye.

The inventors of the present invention have proposed the invention relating to a thermal recording material using an N-substituent amino acid derivative made especially from natural amino acids as a color developer, wherein a functional group that contributes to the required performance and color development ability of the color developer of the thermal recording material is introduced as a protecting group for an amino group of an amino acid, thereby canceling intramolecular neutralization and further strongly expressing the color development ability of an amino acid (Japanese Patent NO. 6726048). The N-substituted amino acid derivative of formula (II) is a color developer described in Japanese Patent NO. 6726048.

Hereinafter, in the present specification, the N-substituted amino acid derivative of formula (II) may be referred to as a color developer (C).

In the thermal recording layer coating material of the present invention or the thermal recording layer in the thermal recording material of the present invention, the color developer (C) is preferably present in an amount from 5 to 400 parts by mass, more preferably from 8 to 300 parts by mass, and still more preferably from 10 to 200 parts by mass per 100 parts of the basic dye of the thermal recording layer, from the viewpoint of color development density and plasticizer resistance.

In the color developer of the present invention, the thermal recording layer coating material of the present invention, or the thermal recording layer in the thermal recording material of the present invention, the content of the color developer (C) is not particularly limited, and from the viewpoint of plasticizer resistance, the color developer (C) may be present in an amount of, for example, 1 or more parts by mass, preferably 3 or more parts by mass, more preferably 4 or more parts by mass, still more preferably 5 or more parts by mass, still more preferably 10 or more parts by mass, preferably 14 or more parts by mass, preferably 20 or more parts by mass, preferably 30 or more parts by mass, preferably 40 or more parts by mass, preferably 60 or more or more, and preferably 80 or more parts by mass. The same applies to the case where the color developer (B) is represented by formula (I-1) and the case where the color developer (B) is represented by formula (I-2).

In the color developer of the present invention, the thermal recording layer coating material of the present invention, or the thermal recording layer in the thermal recording material of the present invention, the upper limit of the content of the color developer (C) per 100 parts of the color developer (B) is not particularly limited, and is preferably set to an appropriate amount within a range in which the effect of the plasticizer resistance can be obtained. Specifically, for example, the upper limit of the content of the color developer (C) may be 500 or less parts by mass, may be 450 or less parts by mass, may be 300 or less parts by mass, may be 200 or less parts by mass, and may be 100 or less parts by mass. The same applies to the case where the color developer (B) is represented by formula (I-1) and the case where the color developer (B) is represented by formula (I-2).

In the thermal recording layer coating material of the present invention or the thermal recording layer in the thermal recording material of the present invention, the total content of the color developer (B) and the color developer (C) is not particularly limited, and from the viewpoint of color development density, the color developer (B) and the color developer (C) are present in an amount, for example, from 1 to 500 parts by mass, 5 to 300 parts by mass, 10 to 200 parts by mass, 10 to 100 parts by mass, 14 to 100 parts by mass, or 30 to 100 parts by mass, and preferably from 35 to 500 parts by mass, more preferably 40 to 400 parts by mass, and still more preferably from 60 to 300 parts by mass per 100 parts of the basic dye of the thermal recording layer, for example. The same applies to the case where the color developer (B) is represented by formula (I-1) and the case where the color developer (B) is represented by formula (I-2).

In the color developer, the thermal recording material, and the thermal recording layer coating material of the present invention, the color developer (B) and the color developer (C) may be used in combination with a color developer other than the color developer (B) and the color developer (C) as long as the effect of the present invention is not hindered. The other color developer is not particularly limited, and may be, for example, a known or existing color developer. When the other color developer is used, one of the other color developers may be used alone or two or more of them may be used in combination.

In the thermal recording material and the thermal recording layer coating material of the present invention, the basic dye which is colorless or light-colored at normal temperature is not particularly limited, and examples thereof include triphenylmethane-based, fluorane-based, diphenylmethane-based, spiro-based, fluorene-based, and thiazine-based compounds. The basic dye which is colorless or light-colored at normal temperature may be selected from, for example, conventionally known leuko dyes. The basic dye which is colorless or light-colored at normal temperature is preferably a colorless or light-colored basic dye which is solid at normal temperature, and more preferably a colorless or light-colored basic dye having a melting point of 60° C. or higher.

In the present invention, “normal temperature” may be, for example, room temperature. In the present invention, “normal temperature” or “room temperature” may be, for example, −10° C. or higher, −5° C. or higher, 0° C. or higher, 5° C. or higher, or 10° C. or higher, and may be, for example, 60° C. or lower, 55° C. or lower, 50° C. or lower, 45° C. or lower, 40° C. or lower, 35° C. or lower, or 30° C. or lower. That is, in the present invention, the “basic dye which is colorless or light-colored at normal temperature” may be, for example, a basic dye which is colorless or light-colored in a temperature range of the “normal temperature” or “room temperature” (for example, a temperature range from −10° C. to 60° C. or 10° C. to 30° C.). In addition, in the present invention, the “colorless or light-colored basic dye which is solid at normal temperature” may be, for example, a colorless or light-colored basic dye which is solid in a temperature range of the “normal temperature” or “room temperature” (for example, a temperature range from −10° C. to 60° C. or 10° C. to 30° C. or the like).

In addition, in the present invention, the “basic dye which is colorless or light-colored at normal temperature” may be any basic dye that can be used for a thermal recording layer of a thermal recording material by developing color by heating. Such a basic dye is not particularly limited, and may be, for example, a basic dye generally used in a thermal recording layer of a thermal recording material, or may be, for example, a conventionally known basic dye as described above. Specific examples thereof are not particularly limited, and are as described above, for example. In the present invention, “light-colored” is not particularly limited, and May be, for example, light yellow, light blue, or the like.

In the thermal recording material and the thermal recording layer coating material of the present invention, specific examples of the basic dye which is colorless or light-colored at normal temperature are as follows, for example. However, in the thermal recording material and the thermal recording layer coating material of the present invention, the basic dye which is colorless or light-colored at normal temperature is not limited to the following specific examples. Further, in the thermal recording material and the thermal recording layer coating material of the present invention, one of the basic dyes which are colorless or light-colored at normal temperature may be used alone or two or more of them may be used in combination.

### Specific Examples (1) of Basic Dye Which is Colorless or Light-Colored at Normal Temperature

3,3-bis(p-dimethylaminophenyl)-6-dimethylaminophthalide, 3,3-bis(p-dimethylaminophenyl) phthalide, 3-(4-diethylamino-2-ethoxyphenyl)-3-(1-ethyl-2-methylindole-3-yl)-4-azaphthalide, 3,3-bis(P-methylaminophenyl)-6-dimethylaminophthalide, 3-diethylamino-7-dibenzylaminobenzo [α]fluorane, 3-(1-ethyl-2-methylindole-3-yl)-3-(4-diethylamino-2-n-hexyloxyphenyl)-4-azaphthalide, 3-(1-ethyl-2-methylindole-3-yl)-3-(4-diethylamino)-2-methylphenyl-4-azaphthalide, 3-(4-diethylaminophenyl)-3-(1-ethyl-2-methylindole-3-yl) phthalide, 3-(2-methyl-1-n-octylindol-3-yl)-3-(4-diethylamino-2-ethoxyphenyl)-4-azaphthalide, 3-(N-ethyl-N-isopentylamino)-6-methyl-7-anilinofluoran, 3-diethylamino-6-methyl-7-anilinofluoran, 3-diethylamino-6-methyl-7-(o,p-dimethylanilino)fluorane

### Specific Examples (2) of Basic Dye Which is Colorless or Light-Colored at Normal Temperature

3-(N-ethyl-N-p-toluidino)-6-methyl-7-anilinofluoran, 3-pyrrolidino-6-methyl-7-anilinofluoran, 3-(N,N-dibutylamino)-6-methyl-7-anilinofluoran, 3-(N-cyclohexyl-N-methylamino)-6-methyl-7-anilinofluoran, 3-diethylamino-7-(o-chloroanilino)fluoran, 3-diethylamino-7-(m-trifluoromethylanilino) fluoran, 3-di(n-pentyl)amino-6-methyl-7-anilinofluoran, 3-[N-(3-etoxypropyl)-N-ethylamino]6-methyl-7-anilinofluoran, 3-(N-n-hexyl-N-ethylamino)-7-(o-chloroanilino) fluoran, 3-(N-ethyl-N-2-tetrahydrofurfurylamino)-6-methyl-7-anilinofluorane, 2,2-bis{4-[6′-(N-cyclohexyl-N-methylamino)-3′-methylspiro[phthalido-3,9′-xanthene]-2′-ylamino]phenyl}propane, and 3-dibutylamino-7-(o-chloroanilino)fluorane

### Specific Examples (3) of Basic Dye Which is Colorless or Light-Colored at Normal Temperature

3,6-dimethoxyfluorane, 3-pyrrolidino-6-chlorofluorane, 3-diethylamino-6-methyl-7-chlorofluorane, 3-diethylamino-7-chlorofluorane, 3-diethylamino-7,8-dibenzofluorane, 3-diethylamino-6,7-dimethylfluorane, 3-(N-methyl-p-toluidino)-7-methylfluorane, 3-(N-methyl-N-isoamylamino)-7,8-benzofluorane, 3,3′-bis(1-n-amyl-2-methylindole-3-yl)phthalide, 3-(N-methyl-N-isoamylamino)-7-phenoxyfluorane, 3,3′-bis(1-n-butyl-2-methylindole-3-yl)phthalide, 3,3′-bis(1-ethyl-2-methylindole-3-yl)phthalide, 3,3′-bis(p-dimethylaminophenyl)phthalide, 3-(N-ethyl-N-p-tolylamino)-7-(N-phenyl-N-methylamino)fluorane, 3-diethylamino-7-anilinofluorane, 3-diethylamino-7-benzylaminofluorane, 3-pyrrolidino-7-dibenzylaminofluorane

As described above, the thermal recording layer in the thermal recording material of the present invention and the thermal recording layer coating material of the present invention include a basic dye which is colorless or light-colored at normal temperature; and a color developer for developing color upon contact with the basic dye by heating, and may or may not include any other optional components.

The optional component may be, for example, a sensitizer. The sensitizer is not particularly limited, and for example, a conventionally known sensitizer can be used in combination. Specific examples of the sensitizer include fatty acid amides such as stearic acid amide, bisstearic acid amide, and palmitic acid amide, and the like; calcium such as p-toluene sulfonamide, stearic acid, behenic acid, palmitic acid, and the like; fatty acid metal salts such as zinc, aluminum, and the like; p-benzylbiphenyl; diphenylsulfone; benzyloxybenzoic acid benzyl; 2-benzyloxynaphthalene; 1,2-bis(p-tolyloxy)ethane; 1,2-bis(phenoxy)ethane; 1,2-bis(3-methylphenoxy)ethane, 1,3-bis(phenoxy)propane; dibenzyl oxalate; p-methylbenzyl oxalate; m-terphenyl; and 1-hydroxy-2-naphthoic acid.

The optional component maybe, for example, a storage stabilizer. The storage stabilizer is not particularly limited, and for example, a conventionally known storage stabilizer can be used in combination. Specific examples of the storage stabilizer include hindered phenol compounds such as 2,2′-methylenebis(4-methyl-6-tert-butylphenol), 2,2′-methylenebis(4-ethyl-6-tert-butylphenol), 2,2′-ethylidenebis(4,6-di-tert-butylphenol), 4,4′-thiobis(2-methyl-6-tert-butylphenol), 4,4′-butylidenebis(6-tert-butyl m-cresol), 1,1,3-tris(2-methyl-4-hydroxy-5-tert-butylphenyl)butane, 1,1,3-tris(2-methyl-4-hydroxy-5-cyclohexylphenyl)butane, 4,4′-bis[(4-methyl-3-phenoxycarbonylaminophenyl) ureido]diphenylsulfone, tris(2,6-dimethyl-4-tert-butyl-3-hydroxybenzyl)isocyanurate, 4,4′-thiobis(3-methylphenol), 4,4′-dihydroxy-3,3′,5,5′-tetrabromodiphenylsulfone, 4,4′-dihydroxy 3,3′,5,5′-tetramethyldiphenylsulfone, 2,2-bis(4-hydroxy-3,5-dibromophenyl) propane, 2,2-bis(4-hydroxy-3,5-dichlorophenyl)propane, 2,2-bis(4-hydroxy-3,5-dimethylphenyl)propane, and the like; epoxy compounds such as 1,4-diglycidyloxybenzene, 4,4′-diglycidyloxydiphenylsulfone, 4-benzyloxy-4′-(2-methylglycyloxy)diphenylsulfone, terephthalic glycidyl, bisphenol A type epoxy resin, cresol novolac type epoxy resin, phenol novolac type epoxy resin, and the like; N,N′-di-2-naphthyl-p-phenylenediamine, sodium salt or polyvalent metal salt of 2,2′-methylenebis(4,6-di-tert-butylphenyl)phosphate; bis(4-ethyleneiminecarbonylaminophenyl)methane; 4,4′-bis[(4-methyl-3-phenoxycarbonylaminophenyl) ureido]diphenylsulfone, and a diphenylsulfone-crosslinked compound of formula (3). These storage stabilizers contribute to the storage stability of the printed part of the thermal recording material.

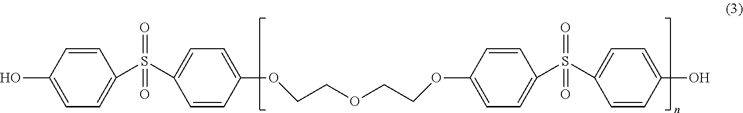

In the formula, n represents an integer of 1 to 7.

When a storage stabilizer is used, the content of the storage stabilizer is not particularly limited, and the storage stabilizer is preferably present in an amount of 2.5 to 100 parts by mass, and more preferably 5 to 50 parts by mass per 100 parts of the total content of the color developer (B) and the color developer (C).

The optional component may be, for example, an auxiliary agent. The auxiliary agent is not particularly limited, and examples thereof include dispersants such as sodium dioctylosuccinate, sodium dodecylbenzene sulfonate, sodium lauryl alcohol sulfate, a fatty acid metal salt, and the like; waxes such as zinc stearate, calcium stearate, polyethylene wax, carnauba wax, paraffin wax, ester wax, and the like; hydrazide compounds such as adipic acid dihydrazide, and the like; water-resistant agents such as glyoxal, boric acid, dialdehyde starch, methylol urea, glyoxylate, an epoxy compound, and the like; defoaming agents; coloring dyes; fluorescent dyes; and pigments.

The optional components used in the thermal recording layer in the thermal recording material of the present invention and the thermal recording layer coating material of the present invention may be, for example, a binder. The binder is not particularly limited, and examples thereof include completely saponified polyvinyl alcohol with a degree of polymerization of 200 to 1900, partially saponified polyvinyl alcohol, carboxy-modified polyvinyl alcohol, diacetone-modified polyvinyl alcohol, acetoacetyl-modified polyvinyl alcohol, amide-modified polyvinyl alcohol, sulfonic acid-modified polyvinyl alcohol, butyral-modified polyvinyl alcohol, hydroxyethylcellulose, methylcellulose, carboxymethylcellulose, styrene-maleic anhydride copolymer, styrene-butadiene copolymer, cellulose derivatives such as ethyl cellulose and acetyl cellulose, polyvinyl acetate, polyacrylamide, polyacrylic acid ester, polyvinyl butyral polystyrene, and copolymers thereof, polyamide resins, silicone resins, petroleum resins, terpene resins, ketone resins, and chroman resins. One of these binders may be used alone or two or more of them may be used in combination. The binders may be used in a state of being dissolved in a solvent, or dispersed in water or other medium in an emulsified or pasty form.

The optional components used in the thermal recording layer in the thermal recording material of the present invention and the thermal recording layer coating material of the present invention may be, for example, a pigment. The pigment is not particularly limited, and may be an inorganic pigment or an organic pigment. Examples of the pigment include silica, kaolin, calcined kaolin, diatomaceous earth, talc, titanium oxide, zinc oxide, aluminum hydroxide, polystyrene resins, urea-formalin resins, styrene-methacrylic acid copolymers, styrene-butadiene copolymers, and hollow plastic pigments.

The type and amount of the basic dye, the color developer, the sensitizer, the binder, the pigment, and other additives used in thermal recording layer in the thermal recording material of the present invention and the thermal recording layer coating material of the present invention are not particularly limited, and can be appropriately determined according to, for example, the quality performance required for the thermal recording layer.

The method for producing the thermal recording layer coating material of the present invention is not particularly limited, and can be produced in the same manner as a general thermal recording layer coating material except that the color developer (B) (the compound of formula (I)) and the color developer (C) (N-substituted amino acid derivative of formula (II)) are used in combination as a color developer, for example. Specifically, for example, the thermal recording layer coating material of the present invention can be produced by adding a binder, a sensitizer, a filler, a lubricant, other additives, and the like in addition to a basic dye which is colorless or light-colored at normal temperature and a color developer for developing color upon contact with the basic dye by heating. The thermal recording layer coating material of the present invention can also be produced, for example, by the production method described in the following Examples.

In the thermal recording material of the present invention, the method for forming the thermal recording layer and the method for producing the thermal recording material are not particularly limited, and may be the same as the general method for forming the thermal recording layer and the general method for producing the thermal recording material except that the thermal recording layer coating material of the present invention is used as the thermal recording layer coating material, for example. Specifically, for example, the thermal recording material of the present invention can be produced by applying the thermal recording layer coating material (coating liquid) of the present invention produced as described above on a support to form a thermal recording layer. In the thermal recording material of the present invention, the support is not particularly limited, and may be, for example, at least one of paper and a film. That is, the thermal recording material of the present invention may be, for example, thermal recording paper in which the support is paper. The thermal recording material of the present invention may be, for example, a thermal recording film in which the support is a film. The paper is not particularly limited, and examples thereof include paper, recycled paper, and synthetic paper. The film is not particularly limited, and examples thereof include a plastic film, a nonwoven fabric, and a metal foil. The support of the present invention may be formed of, for example, a single material, or may be a composite sheet obtained by combining a plurality of materials.

The thermal recording layer in the thermal recording material of the present invention and the thermal recording layer coating material of the present invention preferably contain, for example, 20 to 400 parts by mass of a sensitizer per 100 parts of the basic dye, and preferably contain 5 to 50% by mass of a binder in the total solid content.

The thermal recording material of the present invention may or may not include any optional components other than the support and the thermal recording layer. For example, as the optional component, an overcoat layer made of a polymer material containing an organic pigment may be provided for the purpose of enhancing the storage stability of the thermal recording layer. In addition, for example, an undercoat layer containing an organic pigment, an inorganic pigment, hollow fine particles, or the like may be provided as the optional components for the purpose of preventing the adhesion of grains to the thermal head, improving the print quality, improving the sensitivity, and the like.

In the present invention, the basic dye, the color developer, the sensitizer, and as needed the storage stabilizer and the like used in the thermal recording layer or the thermal recording layer coating material may be used, for example, by pulverizing with water as a dispersion medium using a stirring/grinding machine such as a ball mill, an attritor, a sand mill, or the like so as to achieve the average particle size of 2 μm or less.

By mixing and stirring a pigment, a binder, an auxiliary agent, and the like, as needed, in the dispersed liquid finely dispersed in this manner, it is possible to produce a thermal recording layer coating material as described above.

Further, by applying the thermal recording layer coating material thus obtained on the support and then drying to form a thermal recording layer on the support, the thermal recording material of the present invention can be produced. The application amount of the thermal recording layer coating material on the support is not particularly limited, and the application amount after drying of the thermal recording layer coating material is preferably 1.5 to 12 g/m², and more preferably 3 to 7 g/m², for example.

As the support in the thermal recording material of the present invention, for example, paper, recycled paper, synthetic paper, a plastic film, a nonwoven fabric, metal foil, or the like can be used as described above. A composite sheet obtained by combining these materials can also be used as a support. The thickness of the support is not particularly limited, and can be adjusted appropriately according to the application of the thermal recording material of the present invention, for example.

According to the present invention, it is possible to provide a thermal recording material that satisfies the required performance as a thermal recording material, such as color development density, whiteness, and heat resistance, heat resistance, water resistance, and plasticizer resistance of a printed part.

### EXAMPLES

Hereinafter, Examples of the present invention will be described together with Comparative Examples. However, the present invention is not limited to the following Examples. In the following examples, the term “parts” represents “parts by mass” unless otherwise specified, and “%” represents “% by mass” unless otherwise specified.

In the following Examples, the thermal recording layer coating material and the thermal recording material were produced as follows.

### Preparation of Undercoat Layer Coating Material

An undercoat layer coating material was prepared by mixing 100 parts of plastic hollow particles (trade name: ROPAQU™SN-1055: hollow ratio: 55%, solid content: 26.5%), 100 parts of a 50% dispersion of calcined kaolin, 25 parts of a styrene-butadiene latex (trade name: L-1571, solid content: 48%), 50 parts of a 10% aqueous solution of oxidized starch, and 20 parts of water. This undercoat layer coating material was used for the production of the thermal recording materials in Examples 1 to 14 and Comparative Examples 1 to 10 below.

### Example 1

### Production (Preparation) of Thermal Recording Layer Coating Material

Liquid A (Preparation of Basic Dye Dispersed Liquid)

| | | |
|---|---|---|
| 3-(N,N-dibutylamino)-6-methyl-7-anilinofluoran | 10 | parts |
| 10% polyvinyl alcohol aqueous solution | 10 | parts |
| Water | 16.7 | parts |

Liquid B (Preparation of Color Developer (B) Dispersed Liquid)

| | | |
|---|---|---|
| N-[2-(3-phenylureido)phenyl]benzenesulfonamide | 20 | parts |
| 10% polyvinyl alcohol aqueous solution | 20 | parts |
| Water | 33.3 | parts |

Liquid C (Preparation of Color Developer (C) Dispersed Liquid)

| | | |
|---|---|---|
| N-(m-tolylaminocarbonyl)-phenylalanine | 20 | parts |
| 10% polyvinyl alcohol aqueous solution | 20 | parts |
| Water | 33.3 | parts |

Liquid D (Preparation of Sensitizer Dispersed Liquid)

| | | |
|---|---|---|
| 1,2-bis(3-methylphenoxy)ethane | 15 | parts |
| 10% polyvinyl alcohol aqueous solution | 15 | parts |
| Water | 25 | parts |

Each of the dispersed liquids (liquid A, liquid B, liquid C, and liquid D) was pulverized by a sand grinder until the average particle size became 1 μm or less, and the dispersed liquids were mixed at the following ratios to obtain a coating liquid.

| | | |
|---|---|---|
| Liquid A (basic dye dispersed liquid) | 36.7 | parts |
| Liquid B (color developer (B) dispersed liquid) | 55.0 | parts |
| Liquid C (color developer (C) dispersed liquid) | 18.3 | parts |
| Liquid D (sensitizer dispersed liquid) | 55.0 | parts |

A thermal recording layer coating material of the present Example was prepared by mixing the coating liquid with 27 parts of aluminum hydroxide (trade name: Heidilite® H-42), 10 parts of amorphous silica (trade name: Mizukasil® P-605), 100 parts of 10% lysate of oxidized starch, 19.4 parts of zinc stearate dispersed liquid (trade name: Hidorin® Z-8-36), and 20 parts of water.

### Production (Preparation) of Thermal Recording Material

As a support, high-quality paper (acid paper) having a basis weight of 53 gm² was prepared. An undercoat layer was formed on the support by applying and drying the undercoat layer coating material so as to achieve the mass per area after drying of 6 g/m². A thermal recording layer was formed on the undercoat layer by applying and drying the thermal recording layer coating material of the present Example so as to achieve the mass per area after drying of 3.8 g/m², thereby obtaining a sheet including high-quality paper, an undercoat layer, and a thermal recording layer. The resulting sheet was treated with a super calender so as to have the smoothness of 900 to 1200s, thereby producing (preparing) the thermal recording material of the present Example. The smoothness was measured by a method according to JIS P8155:2010 “Paper and board-Determination of smoothness-Oken method”.

### Various Tests

The following tests 1 to 5 were performed on the thermal recording material produced (prepared) in the present Example.

### 1. Thermal Recording Performance Test (Color Development Test)

An energy of 0.38 mJ/dot was applied to the produced thermal recording material using a thermal recording paper printing tester (TH-PMD manufactured by Ohkura Electric Co., Ltd.). The print density of the recorded part was measured by a Macbeth reflection densitometer (trade name: RD-914, manufactured by Gretag-Macbeth). The resultant was used as a sample (blank).

### 2. Moist Heat Resistance Test

The thermal recording material recorded in the thermal recording performance test was left for 24 hours under an environment of an 90% RH at a test temperature of 40° C., and then the image density of the printed part and the density of the non-printed part of the test piece were measured by the Macbeth reflection densitometer.

### 3. Heat Resistance Test

The thermal recording material recorded in the thermal recording performance test was left for 24 hours under a constant temperature environment at a test temperature of 60° C., and then the image density of the printed part and the density of the non-printed part of the test piece were measured by the Macbeth reflection densitometer.

### 4. Water Resistance Test

The thermal recording material recorded in the thermal recording performance test was immersed in water for 15 hours, and then the test piece was air-dried, and the image density and the non-printed part were measured by the Macbeth reflection densitometer.

### 5. Plasticizer Resistance Test

A lap film (trade name: Hi-Wrap® KMA, manufactured by Mitsui Chemicals, Inc.) was wound in triplicate on a polycarbonate pipe (48 mmφ), thermal recording paper recorded in the thermal recording performance test was placed thereon, and the lap film was again wound in triplicate thereon and left for 24 hours under an environment of 65% RH at 20° C., after which the image density and the non-printed part were measured by the Macbeth reflection densitometer.

The results of the tests 1 to 5 for the thermal recording material of the present Example were as summarized in Table 1 below.

### Example 2

A thermal recording layer coating material of Example 2 and a thermal recording material of Example 2 were prepared in the same manner as in Example 1 except that 55.0 parts of the liquid B and 18.3 parts of the liquid C of Example 1 were changed to 64.1 parts of the liquid B and 9.2 parts of the liquid C. The results of the tests for the thermal recording material according to Example 2 are summarized in Table 1.

### Example 3

A thermal recording layer coating material of Example 3 and a thermal recording material of Example 3 were prepared in the same manner as in Example 1 except that 55.0 parts of the liquid B and 18.3 parts of the liquid C of Example 1 were changed to 69.6 parts of the liquid B and 3.7 parts of the liquid C. The results of the tests for the thermal recording material according to Example 3 are summarized in Table 1.

### Example 4

A thermal recording layer coating material of Example 4 and a thermal recording material of Example 4 were prepared in the same manner as in Example 1 except that 55.0 parts of the liquid B and 18.3 parts of the liquid C of Example 1 were changed to 36.7 parts of the liquid B and 36.7 parts of the liquid C. The results of the tests for the thermal recording material according to Example 4 are summarized in Table 1.

### Example 5

A thermal recording layer coating material of Example 5 and a thermal recording material of Example 5 were prepared in the same manner as in Example 1 except that 55.0 parts of the liquid B and 18.3 parts of the liquid C of Example 1 were changed to 18.3 parts of the liquid B and 55 parts of the liquid C. The results of the tests for the thermal recording material according to Example 5 are summarized in Table 1.

### Example 6

A thermal recording layer coating material of Example 6 and a thermal recording material of Example 6 were prepared in the same manner as in Example 1 except that N-(m-tolylaminocarbonyl)-phenylalanine of the liquid C of Example 1 was changed to N-(phenylaminocarbonyl)-phenylalanine. The results of the tests for the thermal recording material according to Example 6 are summarized in Table 1.

### Example 7

A thermal recording layer coating material of Example 7 and a thermal recording material of Example 7 were prepared in the same manner as in Example 1 except that N-(m-tolylaminocarbonyl)-phenylalanine of the liquid C of Example 4 was changed to N-(phenylaminocarbonyl)-phenylalanine. The results of the tests for the thermal recording material according to Example 7 are summarized in Table 1.

### Comparative Example 1

A thermal recording layer coating material of Comparative Example 1 and a thermal recording material of Comparative Example 1 were prepared in the same manner as in Example 1 except that 55.0 parts of the liquid B and 18.3 parts of the liquid C of Example 1 were changed to 73.3 parts of the liquid B and no liquid C. The results of the tests for the thermal recording material according to Comparative Example 1 are summarized in Table 1.

### Comparative Example 2

A thermal recording layer coating material of Comparative Example 2 and a thermal recording material of Comparative Example 2 were prepared in the same manner as in Example 1 except that 55.0 parts of the liquid B and 18.3 parts of the liquid C of Example 1 were changed to no liquid B and 73.3 parts of the liquid C. The results of the tests for the thermal recording material according to Comparative Example 2 are summarized in Table 1.

### Comparative Example 3

A thermal recording layer coating material of Comparative Example 3 and a thermal recording material of Comparative Example 3 were prepared in the same manner as in

Comparative Example 2 except that N-(m-tolylaminocarbonyl)-phenylalanine of the liquid C of 20) Comparative Example 2 was changed to N-(phenylaminocarbonyl)-phenylalanine. The results of the tests for the thermal recording material according to Comparative Example 3 are summarized in Table 1.

### Comparative Example 4

A thermal recording layer coating material of Comparative Example 4 and a thermal recording material of Comparative Example 4 were prepared in the same manner as in Comparative Example 1 except that N-[2-(3-phenylureido)phenyl]benzenesulfonamide of the liquid B of Comparative Example 1 was changed to bisphenol A. The results of the tests for the thermal recording material according to Comparative Example 4 are summarized in Table 1.

### Comparative Example 5

A thermal recording layer coating material of Comparative Example 5 and a thermal recording material of Comparative Example 5 were prepared in the same manner as in Comparative Example 1 except that N-[2-(3-phenylureido)phenyl]benzenesulfonamide of the liquid B of Comparative Example 1 was changed to bisphenol S. The results of the tests for the thermal recording material according to Comparative Example 5 are summarized in Table 1.

TABLE 1

| | | | Color | Color | Parts of color |
|---|---|---|---|---|---|
| | | | developer (B) | developer (C) | developer (C) per |
| Test | | | (parts by | (parts by | 100 parts of color |
| Examples | Color developer (B) | Color developer (C) | mass) | mass) | developer (B) |
| Ex. 1 | N-[2-(3- | N-(m-tolylaminocarbonyl)- | 150 | 50 | 33.3 |
| | phenylureido)phenyl]benzenesulfonamide | phenylalanine | | | |
| Ex. 2 | N-[2-(3- | N-(m-tolylaminocarbonyl)- | 175 | 25 | 14.3 |
| | phenylureido)phenyl]benzenesulfonamide | phenylalanine | | | |
| Ex. 3 | N-[2-(3- | N-(m-tolylaminocarbonyl)- | 190 | 10 | 5.3 |
| | phenylureido)phenyl]benzenesulfonamide | phenylalanine | | | |
| Ex. 4 | N-[2-(3- | N-(m-tolylaminocarbonyl)- | 100 | 100 | 100.0 |
| | phenylureido)phenyl]benzenesulfonamide | phenylalanine | | | |
| Ex. 5 | N-[2-(3- | N-(m-tolylaminocarbonyl)- | 50 | 150 | 300.0 |
| | phenylureido)phenyl]benzenesulfonamide | phenylalanine | | | |
| Ex. 6 | N-[2-(3- | N-(m-tolylaminocarbonyl)- | 150 | 50 | 33.3 |
| | phenylureido)phenyl]benzenesulfonamide | phenylalanine | | | |
| Ex. 7 | N-[2-(3- | N-(m-tolylaminocarbonyl)- | 100 | 100 | 100.0 |
| | phenylureido)phenyl]benzenesulfonamide | phenylalanine | | | |
| Comp. | N-[2-(3- | Not used | 200 | 0 | 0.0 |
| Ex. 1 | phenylureido)phenyl]benzenesulfonamide | | | | |
| Comp. | Not used | N-(m-tolylaminocarbonyl)- | 0 | 200 | — |
| Ex. 2 | | phenylalanine | | | |
| Comp. | Not used | N-(phenylaminocarbonyl)- | 0 | 200 | — |
| Ex. 3 | | phenylalanine | | | |
| Comp. | Bisphenol A | Not used | 200 | 0 | 0.0 |
| Ex. 4 | | | | | |
| Comp. | Bisphenol S | Not used | 200 | 0 | 0.0 |
| Ex. 5 | | | | | |

| | | Color | Moist | | | |
|---|---|---|---|---|---|---|
| Test | Measured | development | heat | Heat | Water | Plasticizer |
| Examples | part | density | resistance | resistance | resistance | resistance |
| Ex. 1 | Background | 0.05 | 0.05 | 0.06 | 0.05 | 0.05 |
| | part | | | | | |
| | Printed part | 1.32 | 1.25 | 1.25 | 1.22 | 0.65 |
| Ex. 2 | Background | 0.05 | 0.05 | 0.06 | 0.05 | 0.05 |
| | part | | | | | |
| | Printed part | 1.30 | 1.25 | 1.24 | 1.24 | 0.56 |
| Ex. 3 | Background | 0.05 | 0.05 | 0.06 | 0.05 | 0.05 |
| | part | | | | | |
| | Printed part | 1.34 | 1.25 | 1.23 | 1.24 | 0.52 |
| Ex. 4 | Background | 0.05 | 0.05 | 0.06 | 0.62 | 0.05 |
| | part | | | | | |
| | Printed part | 1.33 | 1.26 | 1.21 | 1.20 | 0.68 |
| Ex. 5 | Background | 0.05 | 0.05 | 0.06 | 0.05 | 0.05 |
| | part | | | | | |
| | Printed part | 1.26 | 1.20 | 1.20 | 1.10 | 0.45 |
| Ex. 6 | Background | 0.05 | 0.05 | 0.06 | 0.05 | 0.05 |
| | part | | | | | |
| | Printed part | 1.32 | 1.25 | 1.25 | 1.19 | 0.52 |
| Ex. 7 | Background | 0.05 | 0.05 | 0.06 | 0.62 | 0.05 |
| | part | | | | | |
| | Printed part | 1.33 | 1.26 | 1.21 | 1.18 | 0.55 |
| Comp. | Background | 0.05 | 0.05 | 0.06 | 0.62 | 0.05 |
| Ex. 1 | part | | | | | |
| | Printed part | 1.35 | 1.26 | 1.21 | 1.24 | 0.06 |
| Comp. | Background | 0.05 | 0.05 | 0.06 | 0.05 | 0.05 |
| Ex. 2 | part | | | | | |
| | Printed part | 1.24 | 1.18 | 1.22 | 0.48 | 0.35 |
| Comp. | Background | 0.05 | 0.05 | 0.05 | 0.05 | 0.05 |
| Ex. 3 | part | | | | | |
| | Printed part | 1.18 | 1.15 | 1.16 | 0.42 | 0.35 |
| Comp. | Background | 0.05 | 0.06 | 0.07 | 0.05 | 0.07 |
| Ex. 4 | part | | | | | |
| | Printed part | 1.28 | 1.30 | 1.15 | 0.55 | 0.08 |
| Comp. | Background | 0.05 | 0.05 | 0.06 | 0.06 | 0.06 |
| Ex. 5 | part | | | | | |
| | Printed part | 1.17 | 1.18 | 1.19 | 0.73 | 0.08 |

The thermal recording materials of Examples 1 to 7 were thermal recording materials in which a thermal recording layer that includes an N-(phenylureidophenyl) benzenesulfonamide compound of formula (I) or the formula (I-1) as a color developer (B) and an N-substituted amino acid derivative of formula (II) as a color developer (C) was provided on a support. As is apparent from Table 1, the thermal recording materials of Examples 1 to 7 were superior in plasticizer resistance to the thermal recording material (Comparative Example 1) in which the thermal recording layer including the color developer (B) alone was provided on the support, while maintaining the characteristics of the thermal recording material in which the thermal recording layer including the color developer (B) was provided on the support. Furthermore, the thermal recording materials of Examples 1 to 7 were superior in plasticizer resistance to the thermal recording materials (Comparative Examples 2 to 3) in which the thermal recording layer including the color developer (C) alone was provided on the support.

### Example 8

### Production (Preparation) of Thermal Recording Layer Coating Material

Liquid A (Preparation of Basic Dye Dispersed Liquid)

| | | |
|---|---|---|
| 3-(N,N-dibutylamino)-6-methyl-7-anilinofluoran | 10 | parts |
| 10% polyvinyl alcohol aqueous solution | 10 | parts |
| Water | 16.7 | parts |

Liquid B (Preparation of Color Developer (B) Dispersed Liquid)

| | | |
|---|---|---|
| 3-(3-phenylureido)phenyl-4-methylbenzenesulfonate | 20 | parts |
| 10% polyvinyl alcohol aqueous solution | 20 | parts |
| Water | 33.3 | parts |

Liquid C (Preparation of Color Developer (C) Dispersed Liquid)

| | | |
|---|---|---|
| N-(m-tolylaminocarbonyl)-phenylalanine | 20 | parts |
| 10% polyvinyl alcohol aqueous solution | 20 | parts |
| Water | 33.3 | parts |

Liquid D (Preparation of Sensitizer Dispersed Liquid)

| | | |
|---|---|---|
| 1,2-bis(3-methylphenoxy)ethane | 15 | parts |
| 10% polyvinyl alcohol aqueous solution | 15 | parts |
| Water | 25 | parts |

Each of the dispersed liquids (liquid A, liquid B, liquid C, and liquid D) was pulverized by a sand grinder until the average particle size became lum or less, and the dispersed liquids were mixed at the following ratios to obtain a coating liquid.

| | | |
|---|---|---|
| Liquid A (basic dye dispersed liquid) | 36.7 | parts |
| Liquid B (color developer (B) dispersed liquid) | 55.0 | parts |
| Liquid C (color developer (C) dispersed liquid) | 18.3 | parts |
| Liquid D (sensitizer dispersed liquid) | 55.0 | parts |

A thermal recording layer coating material was produced (prepared) by mixing the coating liquid with 27 parts of aluminum hydroxide (trade name: Heidilite® H-42), 10 parts of amorphous silica (trade name: Mizukasil® P-605), 100 parts of 10% lysate of oxidized starch, 19.4 parts of zinc stearate dispersed liquid (trade name: Hidorin® Z-8-36), and 20 parts of water.

### Production (Preparation) of Thermal Recording Material

As a support, high-quality paper (acid paper) having a basis weight of 53 gm² was prepared. An undercoat layer was formed on the support by applying and drying the undercoat layer coating material so as to achieve the mass per area after drying of 6 g/m². A thermal recording layer was formed on the undercoat layer by applying and drying the thermal recording layer coating material of the present Example so as to achieve the mass per area after drying of 3.8 g/m², thereby obtaining a sheet including high-quality paper, an undercoat layer, and a thermal recording layer. The resulting sheet was treated with a super calender so as to have the smoothness of 900 to 1200s, thereby producing (preparing) the thermal recording material of the present Example. The smoothness was measured by a method according to JIS P8155:2010 “Paper and board-Determination of smoothness-Oken method”.

The following tests 1 to 5 were performed on the thermal recording material of the present Example. The results of the tests were as summarized in Table 2 below.

### Example 9

A thermal recording layer coating material of Example 9 and a thermal recording material of Example 9 were prepared in the same manner as in Example 8 except that 55.0 parts of the liquid B and 18.3 parts of the liquid C of Example 8 were changed to 64.1 parts of the liquid B and 9.2 parts of the liquid C. The results of the tests for the thermal recording material according to Example 9 are summarized in Table 2.

### Example 10

A thermal recording layer coating material of Example 10 and a thermal recording material of Example 10 were prepared in the same manner as in Example 8 except that 55.0 parts of the liquid B and 18.3 parts of the liquid C of Example 8 were changed to 69.6 parts of the liquid B and 3.7 parts of the liquid C. The results of the tests for the thermal recording material according to Example 10 are summarized in Table 2.

### Example 11

A thermal recording layer coating material of Example 11 and a thermal recording material of Example 11 were prepared in the same manner as in Example 8 except that 55.0 parts of the liquid B and 18.3 parts of the liquid C of Example 8 were changed to 36.7 parts of the liquid B and 36.7 parts of the liquid C. The results of the tests for the thermal recording material according to Example 11 are summarized in Table 2.

### Example 12

A thermal recording layer coating material of Example 12 and a thermal recording material of Example 12 were prepared in the same manner as in Example 8 except that 55.0 parts of the liquid B and 18.3 parts of the liquid C of Example 8 were changed to 18.3 parts of the liquid B and 55 parts of the liquid C. The results of the tests for the thermal recording material according to Example 12 are summarized in Table 2.

### Example 13

A thermal recording layer coating material of Example 13 and a thermal recording material of Example 13 were prepared in the same manner as in Example 8 except that N-(m-tolylaminocarbonyl)-phenylalanine of the liquid C of Example 8 was changed to N-(phenylaminocarbonyl)-phenylalanine. The results of the tests for the thermal recording material according to Example 13 are summarized in Table 2.

### Example 14

A thermal recording layer coating material of Example 14 and a thermal recording material of Example 14 were prepared in the same manner as in Example 8 except that N-(m-tolylaminocarbonyl)-phenylalanine of the liquid C of Example 11 was changed to N-(phenylaminocarbonyl)-phenylalanine. The results of the tests for the thermal recording material according to Example 14 are summarized in Table 2.

### Comparative Example 6

A thermal recording layer coating material of Comparative Example 6 and a thermal recording material of Comparative Example 6 were prepared in the same manner as in Example 8 except that 55.0 parts of the liquid B and 18.3 parts of the liquid C of Example 8 were changed to 73.3 parts of the liquid B and no liquid C. The results of the tests for the thermal recording material according to Comparative Example 6 are summarized in Table 2.

### Comparative Example 7

A thermal recording layer coating material of Comparative Example 7 and a thermal recording material of Comparative Example 7 were prepared in the same manner as in Example 8 except that 55.0 parts of the liquid B and 18.3 parts of the liquid C of Example 8 were changed to no liquid B and 73.3 parts of the liquid C. The results of the tests for the thermal recording material according to Comparative Example 7 are summarized in Table 2.

### Comparative Example 8

A thermal recording layer coating material of Comparative Example 8 and a thermal recording material of Comparative Example 8 were prepared in the same manner as in Comparative Example 7 except that N-(m-tolylaminocarbonyl)-phenylalanine of the liquid C of Comparative Example 7 was changed to N-(phenylaminocarbonyl)-phenylalanine. The results of the tests for the thermal recording material according to Comparative Example 8 are summarized in Table 2.

### Comparative Example 9

A thermal recording layer coating material of Comparative Example 9 and a thermal recording material of Comparative Example 9 were prepared in the same manner as in Comparative Example 6 except that 3-(3-phenylureido)phenyl-4-methylbenzenesulfonate of the liquid B of Comparative Example 6 was changed to bisphenol A. The results of the tests for the thermal recording material according to Comparative Example 9 are summarized in Table 2.

### Comparative Example 10

A thermal recording layer coating material of Comparative Example 10 and a thermal recording material of Comparative Example 10 were prepared in the same manner as in Comparative Example 6 except that 3-(3-phenylureido)phenyl-4-methylbenzenesulfonate of the liquid B of Comparative Example 6 was changed to bisphenol S. The results of the tests for the thermal recording material according to Comparative Example 10 are summarized in Table 2.

TABLE 2

| | | | Color | Color | Parts of color |
|---|---|---|---|---|---|
| | | | developer (B) | developer (C) | developer (C) per |
| Test | | | (parts by | (parts by | 100 parts of color |
| Examples | Color developer (B) | Color developer (C) | mass) | mass) | developer (B) |
| Ex. 8 | 3-(3-phenylureido)phenyl-4- | N-(m-tolylaminocarbonyl)- | 15.0 | 5.0 | 33.3 |
| | methylbenzenesulfonate | phenylalanine | | | |
| Ex. 9 | 3-(3-phenylureido)phenyl-4- | N-(m-tolylaminocarbonyl)- | 17.5 | 2.5 | 14.3 |
| | methylbenzenesulfonate | phenylalanine | | | |
| Ex. 10 | 3-(3-phenylureido)phenyl-4- | N-(m-tolylaminocarbonyl)- | 19.0 | 1.0 | 5.3 |
| | methylbenzenesulfonate | phenylalanine | | | |
| Ex. 11 | 3-(3-phenylureido)phenyl-4- | N-(m-tolylaminocarbonyl)- | 10.0 | 10.0 | 100.0 |
| | methylbenzenesulfonate | phenylalanine | | | |
| Ex. 12 | 3-(3-phenylureido)phenyl-4- | N-(m-tolylaminocarbonyl)- | 5.0 | 15.0 | 300.0 |
| | methylbenzenesulfonate | phenylalanine | | | |
| Ex. 13 | 3-(3-phenylureido)phenyl-4- | N-(m-tolylaminocarbonyl)- | 15.0 | 5.0 | 33.3 |
| | methylbenzenesulfonate | phenylalanine | | | |
| Ex. 14 | 3-(3-phenylureido)phenyl-4- | N-(m-tolylaminocarbonyl)- | 10.0 | 10.0 | 100.0 |
| | methylbenzenesulfonate | phenylalanine | | | |
| Comp. | 3-(3-phenylureido)phenyl-4- | Not used | 20.0 | 0.0 | 0.0 |
| Ex. 6 | methylbenzenesulfonate | | | | |
| Comp. | Not used | N-(m-tolylaminocarbonyl)- | 0.0 | 20.0 | — |
| Ex. 7 | | phenylalanine | | | |
| Comp. | Not used | N-(phenylaminocarbonyl)- | 0.0 | 20.0 | — |
| Ex. 8 | | phenylalanine | | | |
| Comp. | Bisphenol A | Not used | 20.0 | 0.0 | 0.0 |
| Ex. 9 | | | | | |
| Comp. | Bisphenol S | Not used | 20.0 | 0.0 | 0.0 |
| Ex. 10 | | | | | |

| | | Color | Moist | | | |
|---|---|---|---|---|---|---|
| Test | Measured | development | heat | Heat | Water | Plasticizer |
| Examples | part | density | resistance | resistance | resistance | resistance |
| Ex. 8 | Background | 0.05 | 0.05 | 0.06 | 0.05 | 0.05 |
| | part | | | | | |
| | Printed part | 1.30 | 1.23 | 1.24 | 1.27 | 0.62 |
| Ex. 9 | Background | 0.05 | 0.05 | 0.06 | 0.05 | 0.05 |
| | part | | | | | |
| | Printed part | 1.29 | 1.21 | 1.21 | 1.26 | 0.52 |
| Ex. 10 | Background | 0.05 | 0.05 | 0.06 | 0.05 | 0.05 |
| | part | | | | | |
| | Printed part | 1.31 | 1.19 | 1.18 | 1.24 | 0.48 |
| Ex. 11 | Background | 0.05 | 0.05 | 0.06 | 0.06 | 0.05 |
| | part | | | | | |
| | Printed part | 1.31 | 1.22 | 1.25 | 1.22 | 0.65 |
| Ex. 12 | Background | 0.05 | 0.05 | 0.06 | 0.05 | 0.05 |
| | part | | | | | |
| | Printed part | 1.26 | 1.20 | 1.25 | 1.15 | 0.41 |
| Ex. 13 | Background | 0.05 | 0.05 | 0.06 | 0.05 | 0.05 |
| | part | | | | | |
| | Printed part | 1.29 | 1.24 | 1.23 | 1.21 | 0.50 |
| Ex. 14 | Background | 0.05 | 0.05 | 0.06 | 0.06 | 0.05 |
| | part | | | | | |
| | Printed part | 1.31 | 1.25 | 1.25 | 1.19 | 0.52 |
| Comp. | Background | 0.05 | 0.05 | 0.06 | 0.06 | 0.05 |
| Ex. 6 | part | | | | | |
| | Printed part | 1.32 | 1.14 | 1.09 | 1.28 | 0.06 |
| Comp. | Background | 0.05 | 0.05 | 0.06 | 0.05 | 0.05 |
| Ex. 7 | part | | | | | |
| | Printed part | 1.24 | 1.18 | 1.22 | 0.48 | 0.35 |
| Comp. | Background | 0.05 | 0.05 | 0.05 | 0.05 | 0.05 |
| Ex. 8 | part | | | | | |
| | Printed part | 1.18 | 1.15 | 1.16 | 0.42 | 0.35 |
| Comp. | Background | 0.05 | 0.06 | 0.07 | 0.05 | 0.07 |
| Ex. 9 | part | | | | | |
| | Printed part | 1.28 | 1.30 | 1.15 | 0.55 | 0.08 |
| Comp. | Background | 0.05 | 0.05 | 0.06 | 0.06 | 0.06 |
| Ex. 10 | part | | | | | |
| | Printed part | 1.17 | 1.18 | 1.19 | 0.73 | 0.08 |

The thermal recording materials of Examples 8 to 14 were thermal recording materials in which a thermal recording layer that includes 3-(3-phenylureido)phenyl-4-methylbenzenesulfonate, which is one of the compounds of formula (I) or the formula (I-2), as a color developer (B) and an N-substituted amino acid derivative of formula (II) as a color developer (C) was provided on a support. As is apparent from Table 2, the thermal recording materials of Examples 8 to 14 were superior in plasticizer resistance to the thermal recording material (Comparative Example 6) in which the thermal recording layer including the color developer (B) alone was provided on the support, while maintaining the characteristics of the thermal recording material in which the thermal recording layer including the color developer

(B) was provided on the support. Furthermore, the thermal recording materials of Examples 8 to 14 were superior in plasticizer resistance to the thermal recording materials (Comparative Examples 7 to 8) in which the thermal recording layer including the color developer (C) alone was provided on the support.

The present invention can be described as, but not limited to, the following supplementary notes.

### Supplementary Note 1

A color developer for a thermal recording layer, including:

a compound of formula (I); and

an N-substituted amino acid derivative of formula (II),

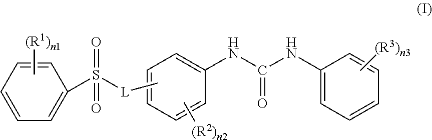

wherein in the formula (I),
L represents an imino group (—NH—) or an oxy group (—O—);
R¹, R² and R³ each represent a hydrogen atom, a halogen atom, a nitro group, an alkyl group, a cycloalkyl group, an alkoxy group, a cycloalkyloxy group, an alkenyl group, a fluoroalkyl group, an N(R⁴)₂ group (wherein R⁴ represents a hydrogen atom, a phenyl group, a benzyl group, or an alkyl group having 1 to 6 carbon atoms), an NHCOR⁵ group (wherein R⁵ represents an alkyl group having 1 to 6 carbon atoms), an optionally substituted phenyl group, an optionally substituted benzyl group, an aryloxy group, an alkylcarbonyloxy group, an arylcarbonyloxy group, an alkylcarbonylamino group, an arylcarbonylamino group, an alkylsulfonylamino group, or an arylsulfonylamino group;
n1, n2 and n3 each independently represent an integer of 0 to 5;
R¹, R² and R³ are identical to or different from one another;
when two or more R¹s are present, R¹s are identical to or different from each other;
when two or more R²s are present, R²s are identical to or different from each other; and
when two or more R³s are present, R³s are identical to or different from each other,

(R⁰—X)—Y—(Z) (II)

Wherein in the formula (II),

R⁰ represents an alkyl group having an aryl group having 6 to 10 carbon atoms or an aryl group optionally substituted with a substituent of an alkyl group having 1 to 8 carbon atoms, an aralkyl group having 7 to 11 carbon atoms, an aryl group having 6 to 10 carbon atoms, or an alkoxy group having 1 to 8 carbon atoms;

X represents a group bonded to an N-terminal of Y and represents —OCO—, —SO₂NHCO—, —NHCO—, —NHCS—, or —SO₂—;
Y represents an amino acid residue or a peptide residue, and an OH group of a serine residue, a threonine residue, an aspartic acid residue, a glutamic acid residue, or a tyrosine residue in the Y group is optionally substituted with an OR⁰ group or an OR″ group, and an SH group of a cysteine residue is optionally substituted with an SR⁰ group or an SR″ group, an NH group of a histidine residue is optionally substituted with an NR⁰ group or an NR′ group, an NH₂ group of a lysine residue or an ornithine residue is optionally substituted with an NHR⁰ group or an NHR′ group, R′ represents an amino protecting group, and R″ represents a carboxy protecting group, provided that Y is an amino acid residue other than a cystine residue or a peptide residue having no cystine residue;
Z is a group bonded to a C-terminal of Y and represents an OH group or an OR″ group;
R⁰, R′ and R″ are identical to or different from one another;
when two or more R⁰s are present, R⁰s are identical to or different from each other;
when two or more R′s are present, R′s are identical to or different from each other;
when two or more R″s are present, R″s are identical to or different from each other; and two or more groups of R⁰, R′, and R″ are optionally bonded to each other to form a ring.

### Supplementary Note 2

The color developer according to Supplementary Note 1, wherein

the N-substituted amino acid derivative of formula (II) is present in an amount of 1 or more parts by mass per 100 parts of the compound of formula (I).

### Supplementary Note 3

The color developer according to Supplementary Note 1 or 2, wherein

the compound of formula (I) is an N-(phenylureidophenyl) benzenesulfonamide compound of formula (I-1),

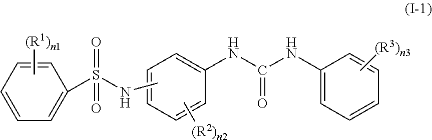

wherein in the formula (I-1),
R¹, R² and R³ each represent a hydrogen atom, a halogen atom, a nitro group, an alkyl group having 1 to 6 carbon atoms, a cycloalkyl group having 1 to 6 carbon atoms, an alkoxy group having 1 to 6 carbon atoms, a cycloalkyloxy group having 1 to 6 carbon atoms, an alkenyl group having 2 to 6 carbon atoms, a fluoroalkyl group having 1 to 6 carbon atoms, an N(R⁴)₂ group (wherein R⁴ represents a hydrogen atom, a phenyl group, a benzyl group, or an alkyl group having 1 to 6 carbon atoms), an NHCOR⁵ group (wherein R⁵ represents an alkyl group having 1 to 6 carbon atoms), an optionally substituted phenyl group, or an optionally substituted benzyl group;
n1 and n3 each independently represent an integer of 1 to 5;
n2 represents an integer of 1 to 4;
R¹, R² and R³ are identical to or different from one another;
when two or more R¹s are present, R¹s are identical to or different from each other;
when two or more R²s are present, R²s are identical to or different from each other; and
when two or more R³s are present, R³s are identical to or different from each other.

### Supplementary Note 4

The color developer according to Supplementary Note 3, wherein

the N-(phenylureidophenyl) benzenesulfonamide compound of formula (I-1) is N-[2-(3-phenylureido) phenyl]benzenesulfonamide.

### Supplementary Note 5

The color developer according to Supplementary Note 3 or 4, wherein

the N-substituted amino acid derivative of formula (II) is present in an amount of 1 to 500 parts by mass per 100 parts of the compound of formula (I-1).

### Supplementary Note 6

The color developer according to Supplementary Note 1 or 2, wherein

the compound of formula (I) is a phenylureidophenyl-benzenesulfonate compound of formula (I-2),

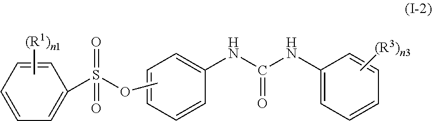

wherein in the formula (I-2),
R¹ and R³ each represent an alkyl group, a cycloalkyl group, an alkoxy group, a cycloalkyloxy group, an aryloxy group, an alkylcarbonyloxy group, an arylcarbonyloxy group, an alkylcarbonylamino group, an arylcarbonylamino group, an alkylsulfonylamino group, or an arylsulfonylamino group;
n1 and n3 each independently represent an integer of 0 to 5;
R¹ and R³ are identical to or different from each other;
when two or more R¹s are present, R¹s are identical to or different from each other; and
when two or more R³s are present, R³s are identical to or different from each other.

### Supplementary Note 7

The color developer according to Supplementary Note 6, wherein the phenylureidophenyl-benzenesulfonate compound of formula (I-2) is 3-(3-phenylureido)phenyl-4-methylbenzenesulfonate.

### Supplementary Note 8

The color developer according to Supplementary Note 6 or 7, wherein

the N-substituted amino acid derivative of formula (II) is present in an amount of 1 to 500 parts by mass per 100 parts of the compound of formula (I-2).

### Supplementary Note 9

The color developer according to any one of Supplementary Notes 1 to 8, wherein

the N-substituted amino acid derivative of formula (II) is N-(m-tolylaminocarbonyl)-phenylalanine or N-(phenylaminocarbonyl)-phenylalanine.

### Supplementary Note 10

A thermal recording material, including:

a support; and

a thermal recording layer on the support, wherein

the thermal recording layer includes:
a basic dye which is colorless or light-colored at normal temperature; and
a color developer for developing color upon contact with the basic dye by heating, wherein
the color developer is the color developer according to any one of

Supplementary Notes 1 to 9.

### Supplementary Note 11

The thermal recording material according to Supplementary Note 10, wherein

the support is at least one of paper or a film.

### Supplementary Note 12

A thermal recording layer coating material for use in forming a thermal recording layer, including:

a basic dye which is colorless or light-colored at normal temperature; and

a color developer for developing color upon contact with the basic dye by heating,

wherein
the color developer is the color developer according to any one of

Supplementary Notes 1 to 9.

### Supplementary Note 13

The thermal recording layer coating material according to Supplementary Note 12, wherein the N-substituted amino acid derivative of formula (II) is present in an amount of 3 parts

by mass or more per 100 parts of the compound of formula (I).

### Supplementary Note 14

The thermal recording layer coating material according to Supplementary Note 12 or 13, which is a thermal recording layer coating material for use in forming the thermal recording layer in the thermal recording material according to Supplementary Note 10 or 11.

While the present invention has been described above with reference to illustrative embodiments (and examples), the present invention is by no means limited thereto. Various combination, changes, and selections may be made freely and appropriately in the configuration and specifics of the present invention without departing from the scope of the present invention.

### INDUSTRIAL APPLICABILITY

As described above, according to the present invention, it is possible to provide a color developer, a thermal recording material, and a thermal recording layer coating material which are excellent in plasticizer resistance. According to the color developer, the thermal recording material, and the thermal recording layer coating material of the present invention, it is also possible to further improve the plasticizer resistance without deteriorating various good storage characteristics such as color development density of the compound of formula (I), whiteness, and the like. The application of the color developer, the thermal recording material, and the thermal recording layer coating material of the present invention is not particularly limited, and for example, can be widely used in the same applications as general color developers, thermal recording materials, and thermal recording layer coating materials, and their industrial applicability is great.

This application claims priority from Japanese Patent Application No. 2020-219044 filed on Dec. 28, 2020 and Japanese Patent Application No. 2021-014999 filed on Feb. 2, 2021. The entire subject matter of the Japanese Patent Application is incorporated herein by reference.

1. A color developer for a thermal recording layer, comprising:
a compound of formula (I); and
an N-substituted amino acid derivative of formula (II), 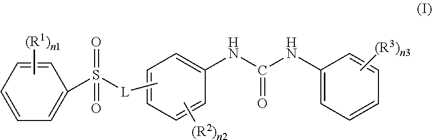
wherein in the formula (I),
L represents an imino group (—NH—) or an oxy group (—O—);
R¹, R² and R³ each represent a hydrogen atom, a halogen atom, a nitro group, an alkyl group, a cycloalkyl group, an alkoxy group, a cycloalkyloxy group, an alkenyl group, a fluoroalkyl group, an N(R⁴)₂ group (wherein R⁴ represents a hydrogen atom, a phenyl group, a benzyl group, or an alkyl group having 1 to 6 carbon atoms), an NHCOR⁵ group (wherein R⁵ represents an alkyl group having 1 to 6 carbon atoms), an optionally substituted phenyl group, an optionally substituted benzyl group, an aryloxy group, an alkylcarbonyloxy group, an arylcarbonyloxy group, an alkylcarbonylamino group, an arylcarbonylamino group, an alkylsulfonylamino group, or an arylsulfonylamino group;
n1, n2 and n3 each independently represent an integer of 0 to 5;
R¹, R² and R³ are identical to or different from one another;
when two or more R¹s are present, R¹s are identical to or different from each other;
when two or more R²s are present, R²s are identical to or different from each other; and
when two or more R³s are present, R³s are identical to or different from each other,
(R⁰—X)—Y—(Z) (II)
wherein in the formula (II),
R⁰ represents an alkyl group having an aryl group having 6 to 10 carbon atoms or an aryl group optionally substituted with a substituent of an alkyl group having 1 to 8 carbon atoms, an aralkyl group having 7 to 11 carbon atoms, an aryl group having 6 to 10 carbon atoms, or an alkoxy group having 1 to 8 carbon atoms;
X represents a group bonded to an N-terminal of Y and represents —OCO—, —SO₂NHCO—, —NHCO—, —NHCS—, or —SO₂—;
Y represents an amino acid residue or a peptide residue, and an OH group of a serine residue, a threonine residue, an aspartic acid residue, a glutamic acid residue, or a tyrosine residue in the Y group is optionally substituted with an OR⁹ group or an OR″ group, and an SH group of a cysteine residue is optionally substituted with an SR⁹ group or an SR″ group, an NH group of a histidine residue is optionally substituted with an NR⁹ group or an NR′ group, an NH₂ group of a lysine residue or an ornithine residue is optionally substituted with an NHR⁹ group or an NHR′ group, R′ represents an amino protecting group, and R″ represents a carboxy protecting group, provided that Y is an amino acid residue other than a cystine residue or a peptide residue having no cystine residue;
Z is a group bonded to a C-terminal of Y and represents an OH group or an OR″ group;
R⁰, R′ and R″ are identical to or different from one another;
when two or more R⁰s are present, R⁰s are identical to or different from each other;
when two or more R′s are present, R′s are identical to or different from each other;
when two or more R″s are present, R″s are identical to or different from each other; and
two or more groups of R⁰, R′, and R″ are optionally bonded to each other to form a ring.

2. The color developer according to claim 1, wherein
the N-substituted amino acid derivative of formula (II) is present in an amount of 1 part by mass or more per 100 parts of the compound of formula (I).

3. The color developer according to claim 1, wherein
the compound of formula (I) is an N-(phenylureidophenyl)benzenesulfonamide compound of formula (I-1), 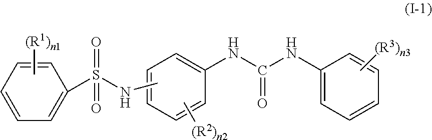
wherein in the formula (I-1),
R¹, R² and R³ each represent a hydrogen atom, a halogen atom, a nitro group, an alkyl group having 1 to 6 carbon atoms, a cycloalkyl group having 1 to 6 carbon atoms, an alkoxy group having 1 to 6 carbon atoms, a cycloalkyloxy group having 1 to 6 carbon atoms, an alkenyl group having 2 to 6 carbon atoms, a fluoroalkyl group having 1 to 6 carbon atoms, an N(R⁴)₂ group (wherein R⁴ represents a hydrogen atom, a phenyl group, a benzyl group, or an alkyl group having 1 to 6 carbon atoms), an NHCOR⁵ group (wherein R⁵ represents an alkyl group having 1 to 6 carbon atoms), an optionally substituted phenyl group, or an optionally substituted benzyl group;
n1 and n3 each independently represent an integer of 1 to 5;
n2 represents an integer of 1 to 4;
R¹, R² and R³ are identical to or different from one another;
when two or more R¹s are present, R¹s are identical to or different from each other;
when two or more R²s are present, R²s are identical to or different from each other; and
when two or more R³s are present, R³s are identical to or different from each other.

4. The color developer according to claim 3, wherein
the N-(phenylureidophenyl)benzenesulfonamide compound of formula (I-1) is N-[2-(3-phenylureido) phenyl]benzenesulfonamide.

5. The color developer according to claim 3, wherein
the N-substituted amino acid derivative of formula (II) is present in an amount of 1 to 500 parts by mass per 100 parts of the compound of formula (I-1).

6. The color developer according to claim 1, wherein
the compound of formula (I) is a phenylureidophenyl-benzenesulfonate compound of formula (I-2), 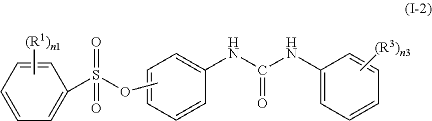
wherein in the formula (I-2),
R¹ and R³ each represent an alkyl group, a cycloalkyl group, an alkoxy group, a cycloalkyloxy group, an aryloxy group, an alkylcarbonyloxy group, an arylcarbonyloxy group, an alkylcarbonylamino group, an arylcarbonylamino group, an alkylsulfonylamino group, or an arylsulfonylamino group;
n1 and n3 each independently represent an integer of 0 to 5;
R¹ and R³ are identical to or different from each other;
when two or more R¹s are present, R¹s are identical to or different from each other; and
when two or more R³s are present, R³s are identical to or different from each other.

7. The color developer according to claim 6, wherein the phenylureidophenyl-benzenesulfonate compound of formula (I-2) is 3-(3-phenylureido)phenyl-4-methylbenzenesulfonate.

8. The color developer according to claim 6, wherein
the N-substituted amino acid derivative of formula (II) is present in an amount of 1 to 500 parts by mass per 100 parts of the compound of formula (I-2).

9. The color developer according to claim 1, wherein
the N-substituted amino acid derivative of formula (II) is N-(m-tolylaminocarbonyl)-phenylalanine or N-(phenylaminocarbonyl)-phenylalanine.

10. A thermal recording material, comprising:
a support; and
a thermal recording layer on the support, wherein
the thermal recording layer comprises:
a basic dye which is colorless or light-colored at normal temperature; and
a color developer for developing color upon contact with the basic dye by heating, wherein
the color developer is the color developer according to claim 1.

11. The thermal recording material according to claim 10, wherein
the support is at least one of paper or a film.

12. A thermal recording layer coating material for use in forming a thermal recording layer, comprising:
a basic dye which is colorless or light-colored at normal temperature; and
a color developer for developing color upon contact with the basic dye by heating, wherein
the color developer is the color developer according to claim 1.

13. The thermal recording layer coating material according to claim 12, wherein
the N-substituted amino acid derivative of formula (II) is present in an amount of 3 parts by mass or more per 100 parts of the compound of formula (I).

14. The thermal recording layer coating material according to claim 12, which is a thermal recording layer coating material for use in forming a thermal recording layer in a thermal recording material, comprising:
a support; and
a thermal recording layer on the support, wherein
the thermal recording layer comprises:
the basic dye which is colorless or light-colored at normal temperature; and
the color developer for developing color upon contact with the basic dye by heating.

15. The color developer according to claim 3, wherein
the N-(phenylureidophenyl)benzenesulfonamide compound of formula (I-1) is N-[2-(3-phenylureido) phenyl]benzenesulfonamide, and
the N-substituted amino acid derivative of formula (II) is N-(m-tolylaminocarbonyl)-phenylalanine or N-(phenylaminocarbonyl)-phenylalanine.

16. The color developer according to claim 6, wherein
the phenylureidophenyl-benzenesulfonate compound of formula (I-2) is 3-(3-phenylureido) phenyl-4-methylbenzenesulfonate, and
the N-substituted amino acid derivative of formula (II) is N-(m-tolylaminocarbonyl)-phenylalanine or N-(phenylaminocarbonyl)-phenylalanine.
